(19) United States
(12) Patent Application Publication
(10) Pub. No.: US 2022/0415050 A1
(43) Pub. Date: Dec. 29, 2022

(54) APPARATUS AND METHOD FOR INCREASING ACTIVATION SPARSITY IN VISUAL MEDIA ARTIFICIAL INTELLIGENCE (AI) APPLICATIONS

(71) Applicant: Intel Corporation, Santa Clara, CA (US)

(72) Inventors: Palanivel Guruva reddiar, Chandler, AZ (US); Siew Hoon Lim, Bayan Lepas (MY); Somnath Paul, Portland, OR (US); Shabbir Abbasali Saifee, Bangalore (IN)

(73) Assignee: Intel Corporation, Santa Clara, CA (US)

(21) Appl. No.: 17/900,697

(22) Filed: Aug. 31, 2022

(51) Int. Cl. G06V 20/40; G06V 10/82; G06T 7/20

(52) U.S. Cl. CPC G06V 20/46; G06V 10/82; G06T 7/20; G06T 2207/20084

(57) ABSTRACT

A Media Analytics Co-optimizer (MAC) engine that utilizes available motion and scene information to increase the activation sparsity in artificial intelligence (AI) visual media applications. In an example, the MAC engine receives video frames and associated video characteristics determined by a video decoder and reformats the video frames by applying a threshold level of motion to the video frames and zeroing out areas that fall below the threshold level of motion. In some examples, the MAC engine further receives scene information from an optical flow engine or event processing engine and reformats further based thereon. The reformatted video frames are consumed by the first stage of AI inference.

### FIELD OF THE SPECIFICATION

This disclosure relates in general to the field of video processing, and more particularly, though not exclusively, to increasing activation sparsity in visual media artificial intelligence (AI) applications.

### BACKGROUND

With the explosive growth in processor architectures' compute capability, combined with the advancements in connectivity technology, such as 5G, edge computing visual media artificial intelligence (AI) applications implemented by video decode and display systems are poised for exponential growth. These advancements will not only accelerate the adoption of existing edge computing visual media AI applications, such as, security, surveillance, and industrial defect detection, but will also enable and introduce new edge computing visual media AI applications. However, the extremely compute-intensive operations that the existing and emerging edge computing visual media AI applications employ present a technical challenge.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 is a functional diagram of a video decode and display system, in accordance with various embodiments.

FIG. 2 illustrates an example flowchart for a method for a video decode and display, in accordance with various embodiments.

FIGS. 3A-3B depict example video frames in various stages of operation of a video decode and display system, in accordance with various embodiments.

FIG. 4 illustrates a modified video frame for the first inference stage, in accordance with certain embodiments.

FIG. 5 illustrates an overview of an edge cloud configuration for edge computing.

FIG. 6 illustrates operational layers among endpoints, an edge cloud, and cloud computing environments.

FIG. 7 illustrates an example approach for networking and services in an edge computing system.

FIG. 8 illustrates a domain topology for respective internet-of-things (IoT) networks coupled through links to respective gateways, according to an example.

FIG. 9 illustrates a cloud computing network in communication with a mesh network of IoT devices operating as a fog device at the Edge of the cloud computing network, according to an example.

FIG. 10 illustrates a drawing of a cloud computing network, or cloud, in communication with a number of Internet of Things (IoT) devices, according to an example.

FIG. 11 illustrates a block diagram for an example IoT processing system architecture upon which any one or more of the techniques (e.g., operations, processes, methods, and methodologies) discussed herein may be performed, according to an example.

FIG. 12 illustrates an overview of layers of distributed compute deployed among an Edge computing system, according to an example.

FIG. 13A provides an overview of example components for compute deployed at a compute node in an edge computing system.

FIG. 13B provides a further overview of example components within a computing device in an edge computing system.

FIG. 14 illustrates an example software distribution platform to distribute software.

### EMBODIMENTS OF THE DISCLOSURE

Many existing and emerging visual media applications employ artificial intelligence (AI) methodologies for video decode and display. For example, edge computing visual media AI applications process incoming visual media using AI to understand a scene. The visual media comprises a large amount of data and the AI processing of the data is compute intensive. This presents an ongoing technical challenge to achieving desirable performance for edge visual media AI applications.

Available technical solutions can be both labor and resource intensive. One available solution employs pruning and quantization of weights (such as, converting 32-bit floating point data to 8-bit integer data) to introduce a “weights sparsity” to frames to improve the AI performance. This solution may additionally down-sample, to a lower resolution, the video signal input, and perform machine vision on the lower resolution frames to achieve their AI performance. However, the weights sparsity of data stored in a matrix is not the same as the activation sparsity of the data. A sparse matrix has more zeros in it compared to a dense matrix, and the larger number of zeros (e.g., higher activation sparsity) makes the sparse matrix easier to compress and store, which improves compute performance on the matrix. Unlike weights, the data for the activations, especially the first layer of activations (the first layer being the decoded video signal) cannot be pruned and quantized to improve the activation sparsity. Moreover, the AI processing on the down-sampled resolution frames require significant compute resources.

In some available solutions, compute-intensive AI processing, such as object detection, is performed on frames selected at regular/periodic intervals (as opposed to performing object detection on every single frame) and the remaining frames (e.g., those that were not selected for object detection) may be subjected to a light-weight object tracking algorithm. These solutions have some drawbacks because applying AI object detection at regular frame intervals can impact the accuracy by missing some objects depending on the interval size, additionally, the AI compute requirements will still be high for the short-interval cases.

Some solutions have introduced dedicated hardware accelerators, such as a Tensor Processor Unit (TPU), which is designed to efficiently handle tasks that are specific to AI, such as object detection, recognition, segmentation, and the like. However, although the dedicated hardware accelerators may speed-up the AI compute process, they have the same power and performance issues when used for edge visual media AI applications.

Another example solution introduces special-purpose deep learning layers that will infer the characteristics of the video signal by performing specific AI tasks to improve the performance of the AI processing functionality. However, the special deep-learning layers can only save the compute time for the intermediate activation layers, and since the first stage of inference and activation (on the decoded video signal) always needs to be performed, this solution has limitations. Moreover, this solution introduces additional compute operations and memory bandwidth.

In the above-described solutions, the motion and scene information (such as the background static regions and foreground moving regions) from other compute components in the AI media system, such as the video decoder, optical flow engine, event processor, etc., are generally not utilized in the inference stages, which are AI compute and bandwidth intensive stages of the AI media system.

Provided embodiments propose a technical solution for the power and performance issues inherent in visual media AI applications, generally, and in edge visual media AI applications, specifically, in the form of a Media Analytics Co-optimizer (MAC) engine that utilizes available motion and scene information to increase the activation sparsity and thereby increase the AI performance without adversely impacting the accuracy of the AI video decode and display system. Furthermore, other desirable features and characteristics of the apparatus and method will become apparent from the subsequent detailed description and the appended claims, taken in conjunction with the accompanying drawings and the preceding background.

The terms “functional block,” “block,” “system,” and “engine” are used herein, with functionality attributed to them. As one with skill in the art will appreciate, the functionality of each of the blocks/systems/engines described herein can individually or collectively be achieved in various ways, such as, via an algorithm implemented in software on a processing unit (CPU, graphics processing unit (GPU), as circuitry, as an application specific integrated circuit, as a field programmable gate array, or the like. The approaches and methodologies presented here can be utilized in various video encoders, computer-based environments, edge computing environments, network environments, and/or database system environments.

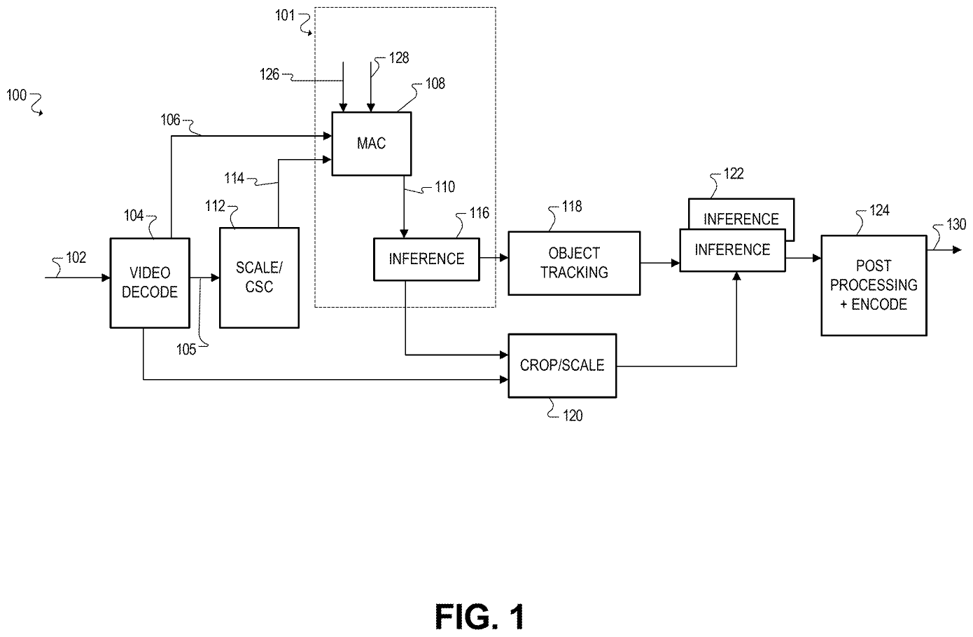

Turning to FIG. 1, a functional block diagram of an improved AI video decode and display system for edge visual media AI applications (also shortened herein to “system” 100) is depicted. The functional blocks are organized as a pipeline from left to right on the page. The system 100 receives a video stream 102, which is input to a video decode block 104.

The video decode block 104 performs video decoding. As is understood by those with skill in the art, video decoding generally includes comparing a first frame to a sequentially second frame to make observations/determinations about areas of motion and areas that lack motion. The video decode block 104 decodes the received video stream 102 into discrete video frames of a scene using video coding data encoded within the video stream 102. Therefore, output 106 from the video decode block 104 may comprise a raw/decoded video frame (e.g., an array of pixels) having a particular video frame size, along with the associated video coding data. Typically, in many available solutions, after decoding and saving the video frame into a storage location (e.g., memory), the video coding data in output 106 may be discarded. As described below, however, the video coding data is not discarded at that point—rather, the video coding data is reused to modify the video frame prior to the inference stage to improve activation sparsity (e.g., by identifying areas of motion within the frame and modifying the frame to preserve the areas of motion while zeroing out the remaining static areas).

Non-limiting examples of the information encoded in video coding data 106 includes motion vectors that indicate motion in the video frame (these vectors may be individually associated with pixels), reference indices for the frame, block type, and transform domain signal-characteristics. Motion vectors capture spatial and temporal position changes, and reference indices are various ways to represent movement changes for the video frame, and/or appearance of new data/objects, within video frames (intra-frame) and between video frames (inter-frame). Block type is generally a pixel-size area, such as 64×64 or 8×8, within which motion is detected (in some cases, the smaller block type represents noise). The transform domain signal characteristic is generated by video compression involving a discrete cosine transform (DCT) based signal processing, and the number of DC and AC coefficients that result from this DCT signal processing provide information about a block's motion.

Output 105, from the video decode block 104, is operated on by a scale/csc block 112 that generates therefrom an output 114 that comprises a scaled and color space converted (csc) video frame.

A first level inference block 116 performs the first stage of inference, which generally means a preliminary object detection and classification (e.g., a vehicle or a person) on the scene depicted in the frame. As used herein, this is referred to as detecting content in the modified video frame, by performing an inference on the modified video frame. In many of the described solutions, the first level inference block 116 operates on only the output from the scale/csc block 112.

As mentioned above, the first stage of inference and activation always needs to be performed, at regular intervals, and this can require a considerable amount of AI compute operations and bandwidth. Accordingly, provided embodiments position the MAC 108 engine prior to the first level inference block 116 to have a direct effect on the computational burden of the first stage of inference (e.g., see block 101 dashed outline). In various embodiments, the previously discarded video decoding data in output 106 and the output 114 from the scale/csc block 112 are collectively referred to as video signal characteristics; the MAC 108 engine consumes and processes the video signal characteristics and generates output 110 based thereon. The output 110 (also referred to herein as a modified frame) has the same frame size as the frame size of the video frame, it is distinguished from the original video frame at least in part by its activation sparsity. In the provided embodiments, the MAC 108 engine output 110, rather than the direct output from the scale/csc block 112, is input to the first level inference block 116. The block 101 may include processing circuitry with an artificial neural net (ANN) trained to detect content in video frames to perform content detection at the first level inference block 116. The operation of the MAC 108 engine and its impact on the performance of the system 100 is described in more detail below.

An object tracking block 118 operates on output from the first level inference block 116 by performing object tracking on the object(s) identified by the first level inference block 116.

A crop/scale block 120 operates on output from the first level inference block 116 and output from the video decode block 104. The crop/scale block 120 reconciles input received from the first level inference block 116 with the video frame output from the video decode block 104. In some embodiments, the output block 114 is included with the output 110.

One or more additional inference blocks 122 perform a second stage of inference, such as identifying a type of vehicle, by receiving and operating on output from the object tracking block 118 and the crop/scale block 120. The one or more additional inference blocks 122 generate a final inference result.

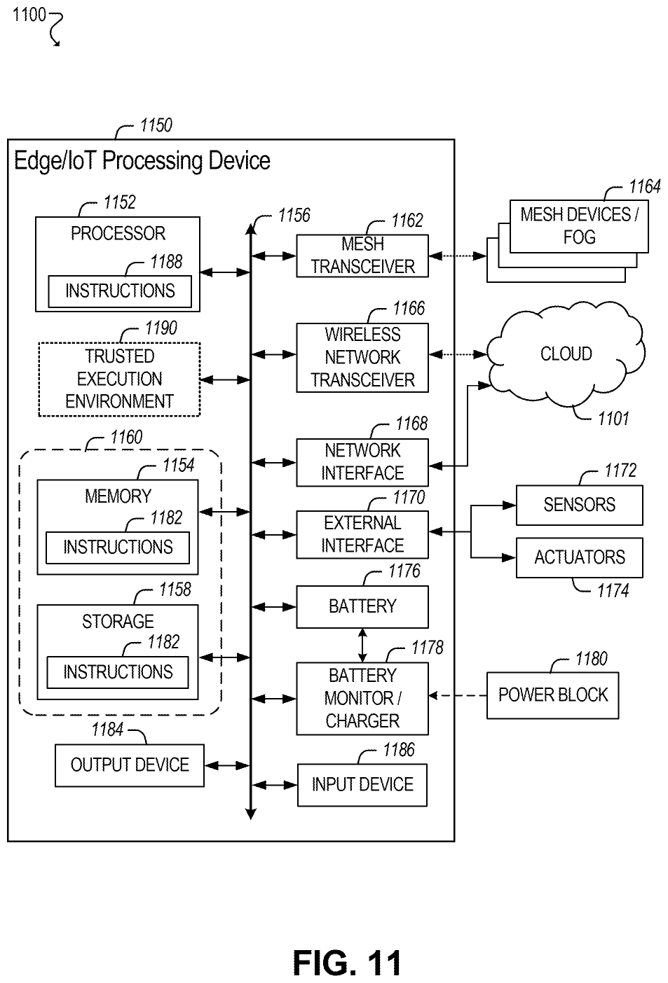

A post processing and encode block 124 receives and operates on the final inference result (from the one or more additional inference blocks 122) to generate output 130. Output 130, from the post processing and encode block 124, may include the final inference results and discrete video frames. Output 130 may be supplied to other nodes in a larger pipeline, such as a cloud server [e.g., FIG. 11, cloud 1101].

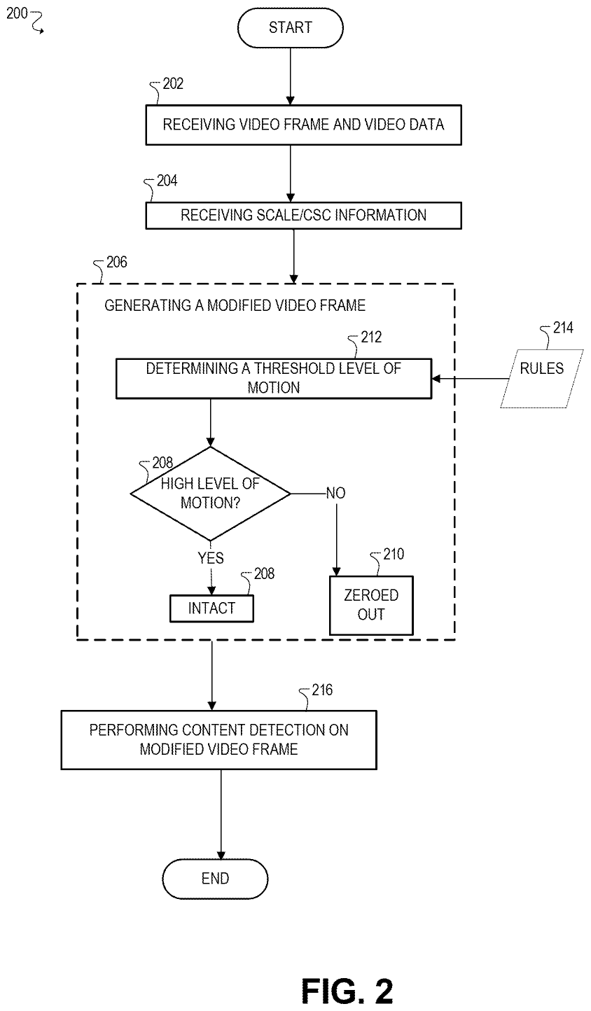

Turning now to FIG. 2 and FIG. 3A-4, the operation of the MAC 108 engine is described. For illustrative purposes, the following description of a method 200 for a MAC 108 engine may refer to elements mentioned above in connection with FIG. 1. In various embodiments, portions of method 200 may be performed by different components of the described system 100. It should be appreciated that method 200 may include any number of additional or alternative operations and tasks, the tasks shown in FIG. 2 need not be performed in the illustrated order, and method 200 may be incorporated into a more comprehensive procedure or method, such as a ride-sharing application, having additional functionality not described in detail herein. Moreover, one or more of the tasks shown in FIG. 2 could be omitted from an embodiment of the method 200 if the intended overall functionality remains intact.

The method 200 increases activation sparsity at the first stage of inference, or the first stage of detecting content. The method 200 accomplishes this by consuming information generated in existing parts of the pipeline in the system 100 and sorting portions in a scene in which a high level of motion is occurring from portions of the scene in which a zero level of motion is occurring, as follows. Prior to operation of the method, a MAC engine software program and associated video decode and display software program may be loaded into and initialized in a computing system (e.g., non-limiting examples include computing circuitry FIG. 1, compute circuitry 1302 or Edge/IOT processing device FIG. 11, cloud 1150). To start the method 200, a video signal may be provided to, for example, a consumer apparatus that employs the circuitry in block 101.

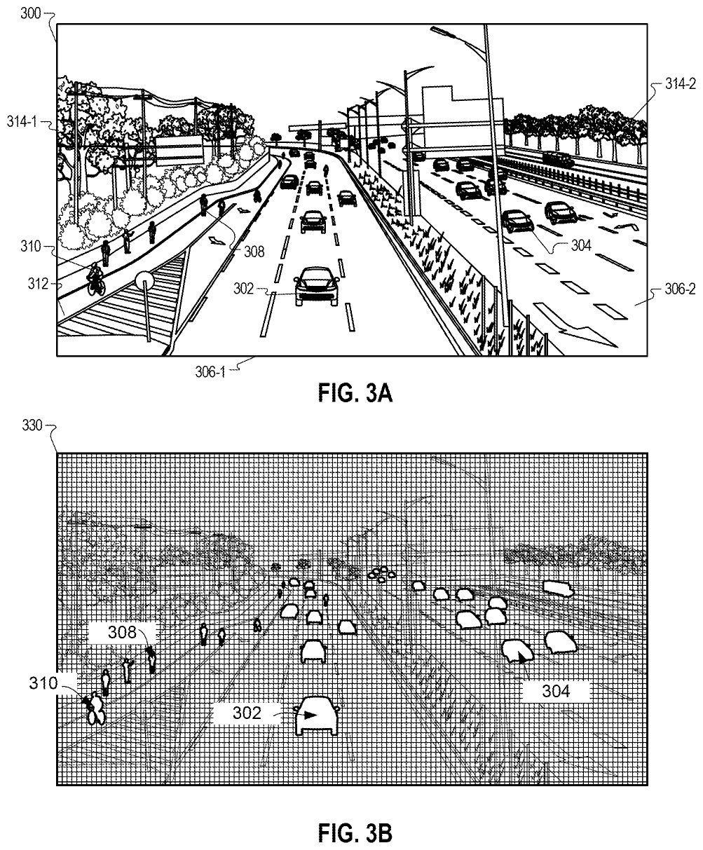

At 202, a video frame and associated video coding data 106 is received. As described herein, the video frame has been decoded from an incoming video signal, by a video decode block that generates the video coding data 106. The video decode block 104 can be separate from or integrated with the MAC 108 engine, or block 101. Accordingly, depending on the implementation, at 202, the MAC 108 engine may actively go to a storage device and retrieve the decoded video frame and associated video coding data 106 or may passively receive it. At 204, scale/csc information (shortened to color space converted (csc) information) may be received by (or retrieved by) the MAC 108 engine. FIG. 3A provides an example video frame 300 for analysis by the improved AI video decode and display system for edge visual media AI applications 100. The scene in the example video frame 300 is an example security camera feed, it includes vehicles (e.g., 302, 304) traveling on multiple lanes (e.g., 306-1, 306-2) of a tree-lined (e.g., 314-1, 314-2) highway, and pedestrians 308 and cyclists 310 on a walkway 312. As may be appreciated, some areas in the video frame 300 are likely to have a high level of motion, some are likely to have a moderate level of motion (e.g., pedestrians), some are likely to have minimal motion (e.g., the trees and plants), and some areas are likely to have no motion (e.g., the pavement). By applying an application-specific threshold level of motion, this video frame 300 can be formatted or modified to increase the activation sparsity. In an example, an application that is directed to viewing vehicles on a highway, may have a higher (larger) threshold level of motion than the threshold level of motion utilized for an application directed to detecting a person walking in a hallway. Accordingly, in various embodiments, a separate preprogrammed set of rules may be referenced on an application-by-application basis to initialize the threshold level of movement.

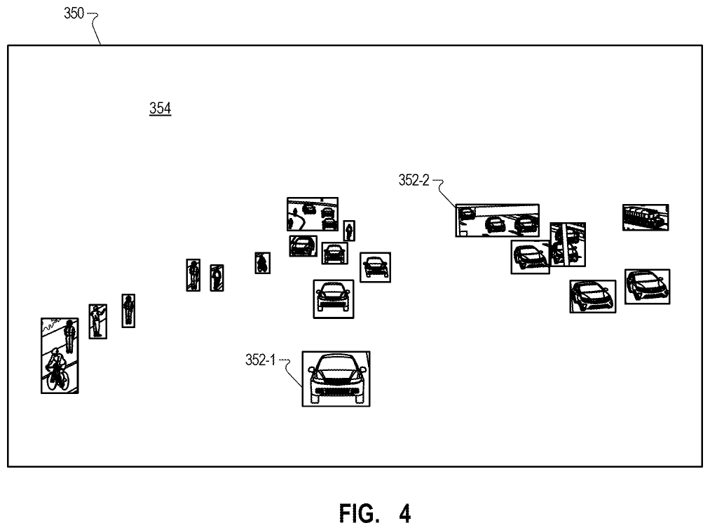

At 206, the method 200 for the MAC 108 engine generates a modified video frame (FIG. 4, 350) based on the video frame and using the video coding data, the modified video frame is characterized by an area 352 having a high level of motion being intact and remaining locations 354 are zeroed out; therefore, the modified video frame has an activation sparsity that is higher than the activation sparsity of the video frame. Said differently, the modified video frame is characterized by an area 352-1 in which a level of motion exceeds a threshold level of motion is intact and remaining locations 354 are zeroed out.

In various embodiments, prior to generating the modified video frame 350, the area 352-1 having a high level of motion may first be determined or identified (at 208) by applying a threshold level of motion to the video frame. The threshold level of motion is a level of motion (or detection of new data or a new object) above which is sorted into “high level” of motion (at 208), and below which will be sorted into “zero level” of motion and zeroed out (at 210) at the level of a pixel or block type. Performing this operation includes comparing motion data from individual locations in the video frame to the threshold. In some embodiments, this may be comparing a pixel to a pixel, a block to a block, or another similar data comparison. The method 200 or apparatus keeps intact (e.g., unaltered or unmodified) the image data at locations in which motion in the video frame exceeds the threshold and the method or apparatus modifies remaining locations (those that do not exceed the threshold) such that they are “zeroed out.”

The concept of zeroing out, as used herein to increase activation sparsity of the input to the first inference stage (e.g., in block 101), can mean literally replacing, in the video frame, image data or a value at a pixel, block, sub-block, or the like, with a zero, “null value,” “empty value,” a single constant, or one of multiple constants that are arbitrarily assigned for every location not exceeding the threshold. In various embodiments, the constant (or constants) used to increase activation sparsity depends on the color space and the way the processing circuitry and/or ANN has been AI optimized at to handle the activation sparsity data. Said differently, the apparatus modifies remaining locations (those that do not exceed the threshold) by filling the locations with a constant or constants determined (by the apparatus) to increase the activation sparsity of the modified frame as compared to that of the original video frame. The concept of zeroing out, as used herein can also mean masking the image data, such that the image data is still in the modified video frame but is not processed in the first inference stage.

FIG. 3B image 330 illustrates an intermediate frame, showing the video frame represented as a grid, in which areas determined to have a high level of motion are distinguished from remaining locations. Vehicles (e.g., 302, 304), pedestrians 308, and cyclists 310 are visually distinguished in image 330, by being filled white. Although the image 330 illustrates the high level of motion areas filled white (as compared to the threshold level of motion), one with skill in the art will recognize that this visual distinction is used to assist presenting the thresholding and modifying operations, and does not necessarily represent how the video frame data is stored by the method 200. As mentioned, the determination for which areas to distinguish is made by the MAC 108 engine, using a threshold level of motion.

Further, in various embodiments, at 208, the MAC 108 engine uses the received video signal characteristics described above (the video decoding data 106 and csc information output 114) to determine the threshold level of motion (at 212). As may be appreciated, the threshold level of motion may vary; accordingly, the MAC 108 engine may reference preprogrammed application-specific or environment-specific rules to determine the threshold level of motion. In some embodiments, the MAC 108 engine may receive and process input from other compute blocks in a video decode and display system, such as, but not limited to, input 126 from an optical flow engine and/or input 128 from an event processor. The optical flow engine can be a hardware solution or a software solution implemented in a CPU, graphics processing unit (GPU), or video encoder, or the like, programmed to be a source of object movement information by (e.g., in a non-limiting example) identifying an object and putting a bounding box around the object in a first frame and calculating the motion belonging to the object in a subsequent frame or frames, such as, by of the pixels (or blocks). The event processor can also be a hardware solution, or a software solution implemented in a CPU, graphics processing unit (GPU), or video encoder, or the like, programmed to be a source of event information, where an event can be a system interrupt, user input, or other similar action. In these embodiments, the threshold level of motion (and output 110) is further based on input 126 and/or input 128.

In practice, and as the illustrations in FIG. 3A-C depict, at 206 there may be multiple independent areas in the video frame in which motion that exceeds a threshold level of motion (e.g., “high level of motion”) is identified (such as, area 352-1 and area 352-2); accordingly, at 206, the modified video frame 350 is generated with the multiple areas independently intact, with remaining locations zeroed out. The modified video frame 350 only keeps intact the areas of the video frame in which the motion exceeds the threshold level of motion is observed and/or there is an appearance of new data; the remainder of the pixels in the modified video frame are zeroed out/blacked out, replaced with zero-value pixels, or otherwise masked. Described differently, the MAC 108 engine determines how and when to black out pixels/regions in a video frame.

At 216, the modified video frame 350 is available for consumption by the first stage of inference of the video decode and display system, at the first level inference block 116. In various embodiments, at 216, the first level inference block 116 performs content detection on the modified video frame 350, e.g., by including processing circuitry with an artificial neural net (ANN) to perform content detection at the first level inference block 116. In some embodiments, the functionality is integrated, such that, e.g., the block 101, includes the MAC 108 engine plus the processing circuitry with an artificial neural net (ANN) to perform content detection at the first level inference block 116, and it is block 101 that generates the output of the content detection from the first level of inference. The blacked-out or zero value pixels/locations 354 in the modified video frame 350 save AI compute time over that which would have been required for the original video frame in the AI compute stage of the first level inference block 116.

After 216 the method may repeat or end.

Test results demonstrate that this methodology does not adversely impact the accuracy of the system 100 (e.g., test results indicated the MAC 108 engine reduced processing time by over 78% while providing an accuracy of about 96% compared to the same video decode and display pipeline without the MAC 108 engine).

Advantageously, the MAC 108 engine operates on a same video frame that would otherwise be fed to the first level inference block 116, hence not introducing any additional video frame related requirements. The MAC 108 engine consumes or re-uses data that is already available from the output of the existing video decode block 104 (in many available solutions this data would be discarded). Viewed differently, the MAC 108 engine performs a preprocessing function for the first level inference block 116 by re-formatting video frames from the received video stream 102 to increase the activation sparsity while leaving the frame size the same and without impacting the inference accuracy of the first level inference block 116.

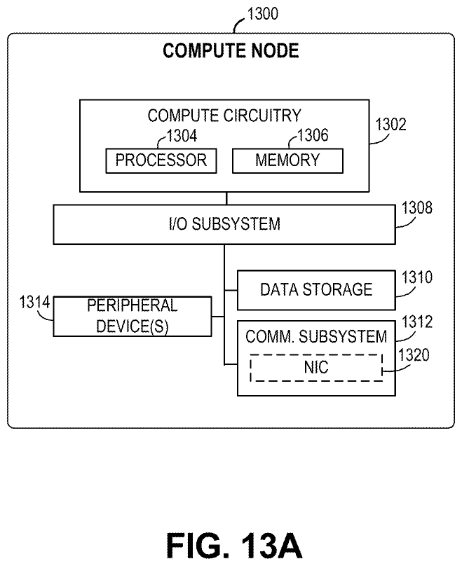

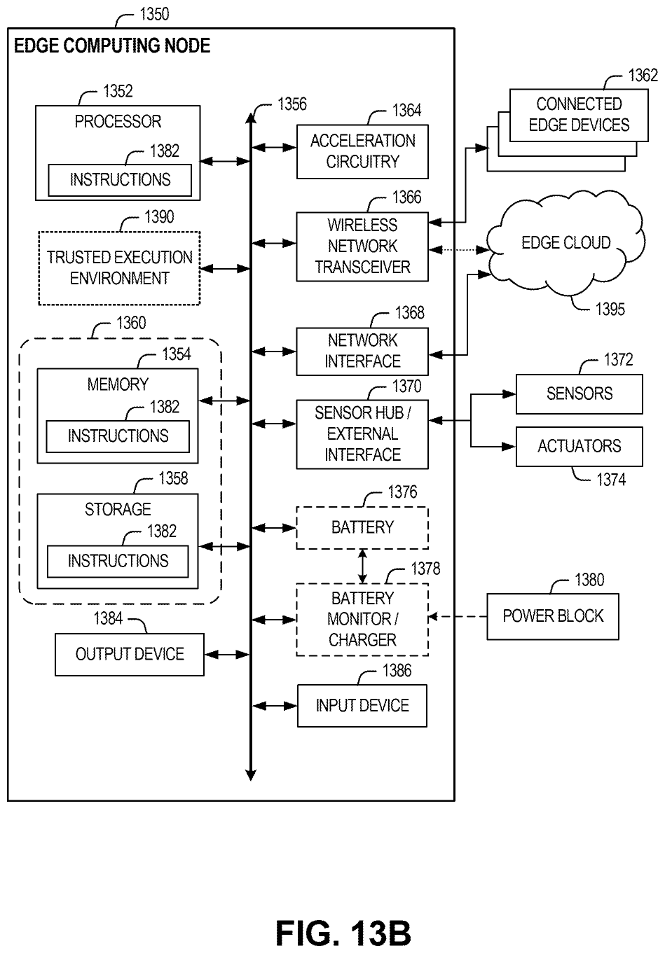

As mentioned above, the MAC 108 engine can be implemented as a software algorithm executed by a CPU or GPU, as circuitry, as an application specific integrated circuit, as a field programmable gate array, or the like, so long as the MAC 108 engine either has integrated therewith or has access to the DRAM in an AI media system. In some embodiments (e.g., FIG. 13, storage 1310), the system 100 may include a system DRAM configured with an intellectual property (IP) compression engine. In these embodiments, the output 110 of the MAC 108 engine could be efficiently compressed by the system DRAM, resulting in better power and performance as the DRAM bandwidth would get reduced substantially.

Thus, an apparatus and method for a MAC 108 engine for improving activation sparsity in visual media AI applications is described. Advantageously, the MAC 108 engine is independent of the AI compute operations of the first stage of inference and can therefore be paired with a variety of different AI inference topology/engines. Using the MAC 108 engine does not require performance of any additional video frame related processing (such as, scaling and color space conversions) because it operates on the same video frame that would otherwise be fed to the first stage of inference. Using the MAC 108 engine also does not require retraining of an existing AI inference stage, because the MAC 108 engine simply formats the initial activation layer to improve the AI performance at the first stage of inference. The MAC 108 engine can be implemented as a block that is easily turned on/turned off, based on end-application needs, and can easily be integrated with the existing software stack. Utilizing the MAC 108 engine advantageously can reduce memory bandwidth requirements and power requirements, as the improved activation sparsity will help to efficiently compress the data traffic between DRAM and the AI media system.

In some embodiments, the MAC 108 engine may be implemented within a video decode and display system that is implemented as a system-on-a-chip (SoC), discrete graphics card, or custom ASIC/FPGA video processor, among other examples. Moreover, in some embodiments, system 100 may be part of a broader device or system, such as a digital media player (e.g., video streaming device, disc-based media player such as Blu-Ray or DVD, projector), a digital display device or system (e.g., television, monitor, interactive flat panel display/interactive whiteboard, touchscreen display, digital sign, multi-display video wall), a video wall controller (e.g., a physical case or housing with one or more processing devices to drive the displays of a video wall), a client device (e.g., personal computer, laptop, tablet, mobile device/phone), a video game console, or an edge computing appliance (e.g., edge server), among other examples.

In various embodiments, the system 100 may include any combination of hardware circuitry and/or software for performing the operations described herein. For example, the system 100 may be implemented on a CPU, GPU, VPU, TPU, ASIC, or FPGA. Examples of additional tasks that may be performed by the system 100 include video encoding/decoding, preprocessing (e.g., color space conversion, scaling resizing, cropping), pixel segmentation, feature detection/extraction, object detection/tracking, object identification, facial recognition, event/action detection, scene recognition, motion estimation, pose estimation, camera/sensor fusion (e.g., fusing together visual/sensor data captured by multiple homogenous or heterogenous vision sensors, such as cameras, thermal sensors, lidar, radar), and so forth.

Moreover, the tasks, processing modules, and/or models used by the system 100 may be implemented using any suitable visual processing, artificial intelligence, and/or machine learning techniques, including artificial neural networks (ANNs), deep neural networks (DNNs), convolutional neural networks (CNNs) (e.g., Inception/ResNet CNN architectures), other deep learning neural networks or feed-forward artificial neural networks, pattern recognition, scale-invariant feature transforms (SIFT), principal component analysis (PCA), discrete cosine transforms (DCT), and so forth.

### Example Computing Embodiments

The following sections present examples of various computing embodiments that may be used to implement the multi-stream video processing solution described throughout this disclosure. In particular, any of the devices, systems, or functionality described in the preceding sections may be implemented using the computing embodiments described below.

### Edge Computing

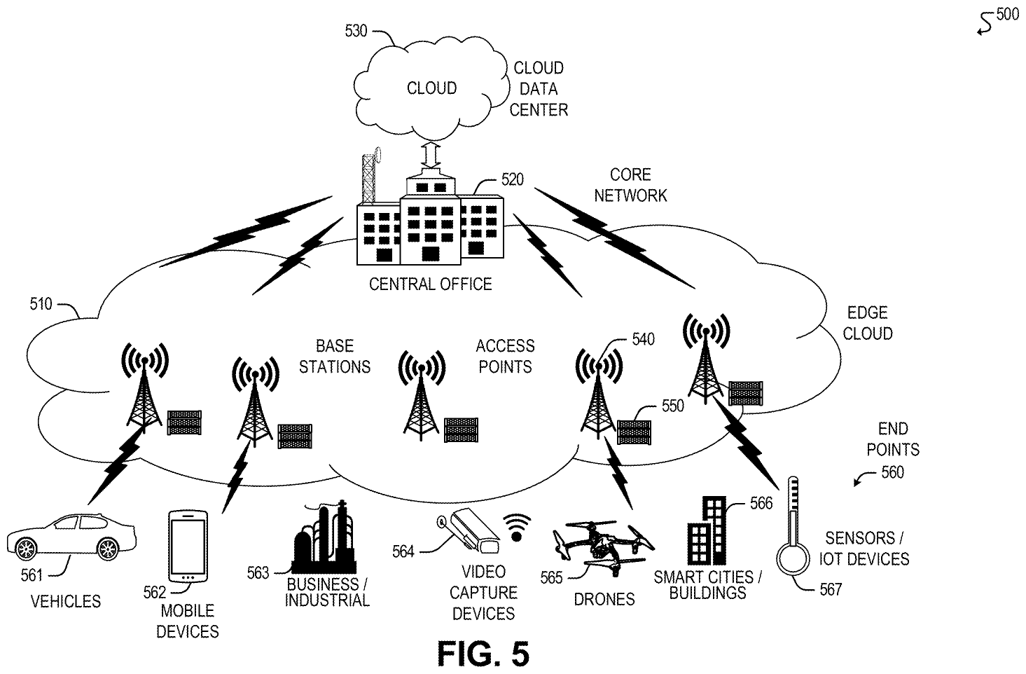

FIG. 5 is a block diagram 500 showing an overview of a configuration for edge computing, which includes a layer of processing referred to in many of the following examples as an “edge cloud”. As shown, the edge cloud 510 is co-located at an edge location, such as an access point or base station 540, a local processing hub 550, or a central office 520, and thus may include multiple entities, devices, and equipment instances. The edge cloud 510 is located much closer to the endpoint (consumer and producer) data sources 560 (e.g., autonomous vehicles 561, user equipment 562, business and industrial equipment 563, video capture devices 564, drones 565, smart cities and building devices 566, sensors and IoT devices 567, etc.) than the cloud data center 530. Compute, memory, and storage resources which are offered at the edges in the edge cloud 510 are critical to providing ultra-low latency response times for services and functions used by the endpoint data sources 560 as well as reduce network backhaul traffic from the edge cloud 510 toward cloud data center 530 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the number of resources needed for network services, through the distribution of more resources which are located closer both geographically and in network access time. In this manner, edge computing attempts to bring the compute resources to the workload data where appropriate or bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

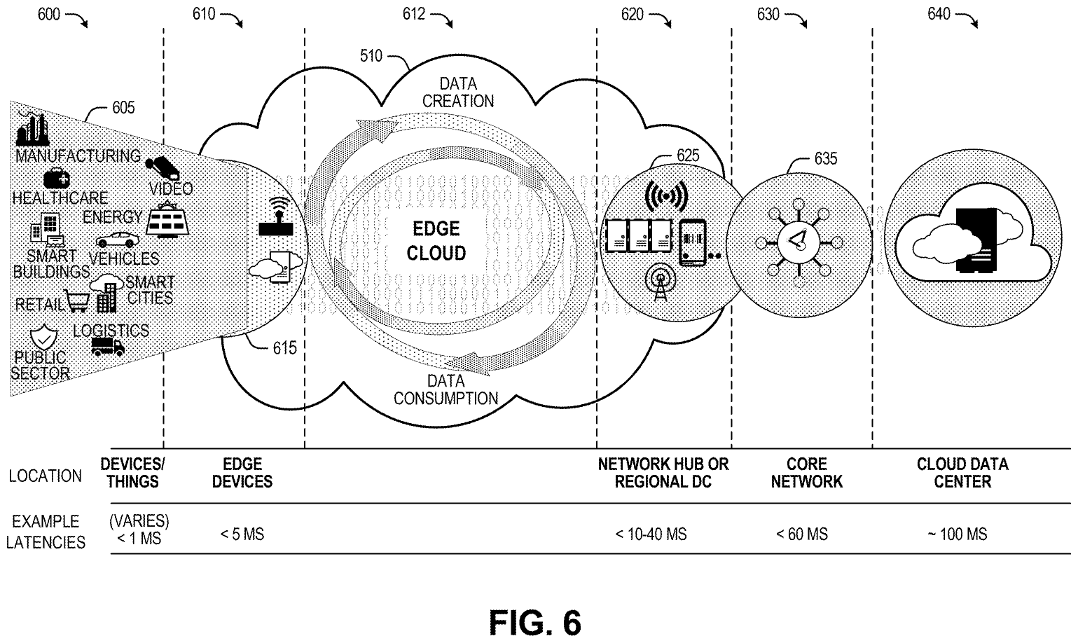

FIG. 6 illustrates operational layers among endpoints, an edge cloud, and cloud computing environments. Specifically, FIG. 6 depicts examples of computational use cases 605, utilizing the edge cloud 510 among multiple illustrative layers of network computing. The layers begin at an endpoint (devices and things) layer 600, which accesses the edge cloud 510 to conduct data creation, analysis, and data consumption activities. The edge cloud 510 may span multiple network layers, such as an edge devices layer 610 having gateways, on-premise servers, or network equipment (nodes 615) located in physically proximate edge systems; a network access layer 620, encompassing base stations, radio processing units, network hubs, regional data centers (DC), or local network equipment (equipment 625); and any equipment, devices, or nodes located therebetween (in layer 612, not illustrated in detail). The network communications within the edge cloud 510 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 600, under 5 ms at the edge devices layer 610, to even between 10 to 40 ms when communicating with nodes at the network access layer 620. Beyond the edge cloud 510 are core network 630 and cloud data center 640 layers, each with increasing latency (e.g., between 50-60 ms at the core network layer 630, to 100 or more ms at the cloud data center layer). As a result, operations at a core network data center 635 or a cloud data center 645, with latencies of at least 50 to 100 ms or more, will not be able to accomplish many time-critical functions of the use cases 605. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 635 or a cloud data center 645, a central office or content data network may be considered as being located within a “near edge” layer (“near” to the cloud, having high latency values when communicating with the devices and endpoints of the use cases 605), whereas an access point, base station, on-premise server, or network gateway may be considered as located within a “far edge” layer (“far” from the cloud, having low latency values when communicating with the devices and endpoints of the use cases 605). It will be understood that other categorizations of a particular network layer as constituting a “close”, “local”, “near”, “middle”, or “far” edge may be based on latency, distance, number of network hops, or other measurable characteristics, as measured from a source in any of the network layers 600-640.

The various use cases 605 may access resources under usage pressure from incoming streams, due to multiple services utilizing the edge cloud. To achieve results with low latency, the services executed within the edge cloud 510 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 510 may provide the ability to serve and respond to multiple applications of the use cases 605 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required because edge locations may be unmanned and may even need permissioned access (e.g., when housed in a third-party location). Such issues are magnified in the edge cloud 510 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 510 (network layers 600-640), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 510.

As such, the edge cloud 510 is formed from network components and functional features operated by and within edge gateway nodes, edge aggregation nodes, or other edge compute nodes among network layers 610-630. The edge cloud 510 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 510 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

The network components of the edge cloud 510 may be servers, multi-tenant servers, appliance computing devices, and/or any other type of computing devices. For example, the edge cloud 510 may include an appliance computing device that is a self-contained electronic device including a housing, a chassis, a case, or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 1B. The edge cloud 510 may also include one or more servers and/or one or more multi-tenant servers. Such a server may include an operating system and implement a virtual computing environment. A virtual computing environment may include a hypervisor managing (e.g., spawning, deploying, destroying, etc.) one or more virtual machines, one or more containers, etc. Such virtual computing environments provide an execution environment in which one or more applications and/or other software, code or scripts may execute while being isolated from one or more other applications, software, code, or scripts.

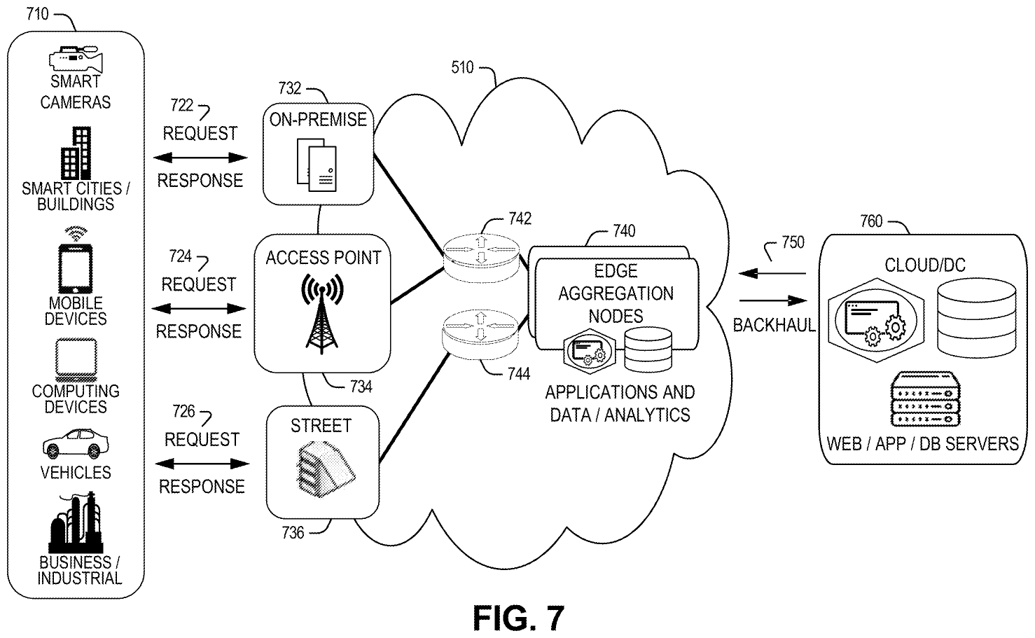

In FIG. 7, various client endpoints 610 (in the form of smart cameras, mobile devices, computers, autonomous vehicles, business computing equipment, industrial processing equipment) exchange requests and responses that are specific to the type of endpoint network aggregation. For instance, client endpoints 610 may obtain network access via a wired broadband network, by exchanging requests and responses 622 through an on-premise network system 632. Some client endpoints 610, such as smart cameras, may obtain network access via a wireless broadband network, by exchanging requests and responses 624 through an access point (e.g., cellular network tower) 634. Some client endpoints 610, such as autonomous vehicles may obtain network access for requests and responses 626 via a wireless vehicular network through a street-located network system 636. However, regardless of the type of network access, the TSP may deploy aggregation points 642, 644 within the edge cloud 510 to aggregate traffic and requests. Thus, within the edge cloud 510, the TSP may deploy various compute and storage resources, such as at edge aggregation nodes 640, to provide requested content. The edge aggregation nodes 640 and other systems of the edge cloud 510 are connected to a cloud or data center 660, which uses a backhaul network 650 to fulfill higher-latency requests from a cloud/data center for websites, applications, database servers, etc. Additional or consolidated instances of the edge aggregation nodes 640 and the aggregation points 642, 644, including those deployed on a single server framework, may also be present within the edge cloud 510 or other areas of the TSP infrastructure.

### Internet-of-Things

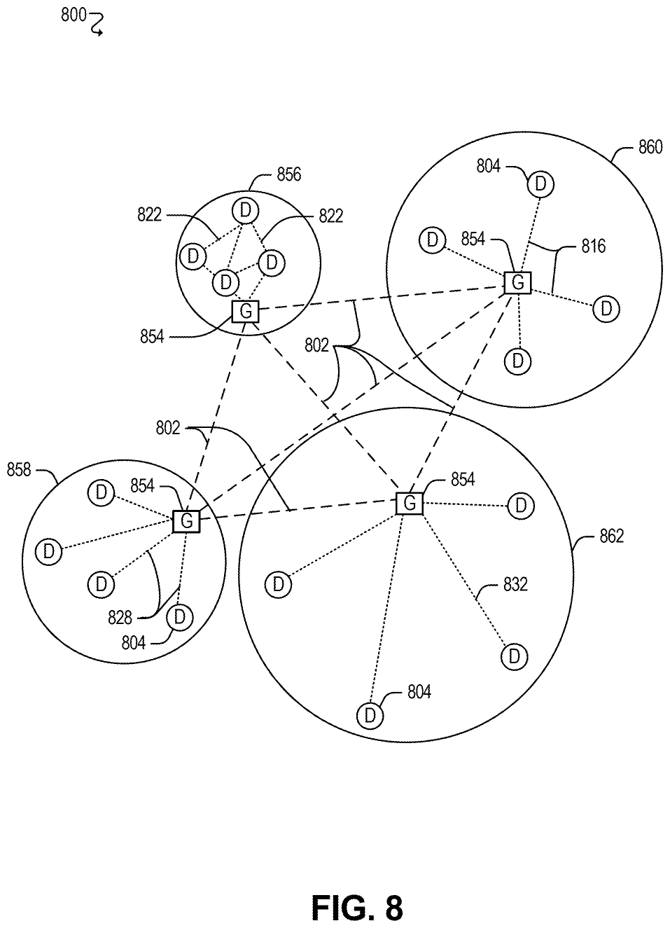

FIG. 8 illustrates an example domain topology for respective internet-of-things (IoT) networks coupled through links to respective gateways. The internet of things (IoT) is a concept in which a large number of computing devices are interconnected to each other and to the Internet to provide functionality and data acquisition at very low levels. Thus, as used herein, an IoT device may include a semiautonomous device performing a function, such as sensing or control, among others, in communication with other IoT devices and a wider network, such as the Internet.

Often, IoT devices are limited in memory, size, or functionality, allowing larger numbers to be deployed for a similar cost to smaller numbers of larger devices. However, an IoT device may be a smart phone, laptop, tablet, or PC, or another larger device. Further, an IoT device may be a virtual device, such as an application on a smart phone or other computing device. IoT devices may include IoT gateways, used to couple IoT devices to other IoT devices and to cloud applications, for data storage, process control, and the like.

Networks of IoT devices may include commercial and home automation devices, such as water distribution systems, electric power distribution systems, pipeline control systems, plant control systems, light switches, thermostats, locks, doorbells (e.g., doorbell cameras), cameras, alarms, motion sensors, and the like. The IoT devices may be accessible through remote computers, servers, and other systems, for example, to control systems or access data.

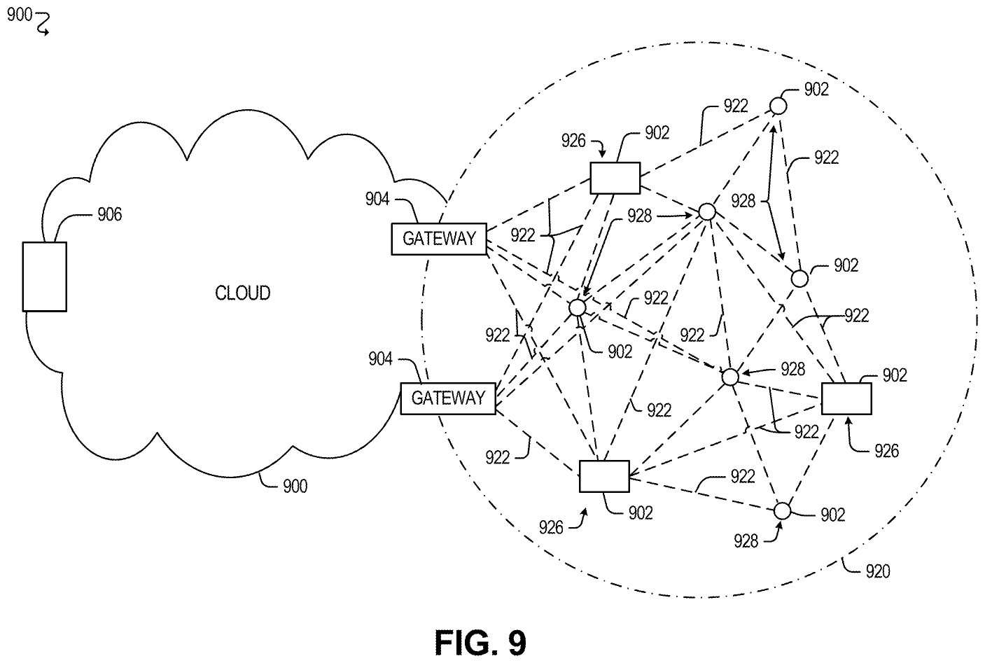

The future growth of the Internet and like networks may involve very large numbers of IoT devices. Accordingly, in the context of the techniques discussed herein, a number of innovations for such future networking will address the need for all these layers to grow unhindered, to discover and make accessible connected resources, and to support the ability to hide and compartmentalize connected resources. Any number of network protocols and communications standards may be used, wherein each protocol and standard are designed to address specific objectives. Further, the protocols are part of the fabric supporting human accessible services that operate regardless of location, time, or space. The innovations include service delivery and associated infrastructure, such as hardware and software; security enhancements; and the provision of services based on Quality of Service (QoS) terms specified in service level and service delivery agreements. As will be understood, the use of IoT devices and networks, such as those introduced in FIGS. 8 and 9, present a number of new challenges in a heterogeneous network of connectivity comprising a combination of wired and wireless technologies.

FIG. 8 specifically provides a simplified drawing of a domain topology that may be used for a number of internet-of-things (IoT) networks comprising IoT devices 804, with the IoT networks 856, 858, 860, 862, coupled through backbone links 802 to respective gateways 854. For example, a number of IoT devices 804 may communicate with a gateway 854, and with each other through the gateway 854. To simplify the drawing, not every IoT device 804, or communications link (e.g., link 816, 822, 828, or 832) is labeled. The backbone links 802 may include any number of wired or wireless technologies, including optical networks, and may be part of a local area network (LAN), a wide area network (WAN), or the Internet. Additionally, such communication links facilitate optical signal paths among both IoT devices 804 and gateways 854, including the use of MUXing/deMUXing components that facilitate interconnection of the various devices.

The network topology may include any number of types of IoT networks, such as a mesh network provided with the network 856 using Bluetooth low energy (BLE) links 822. Other types of IoT networks that may be present include a wireless local area network (WLAN) network 858 used to communicate with IoT devices 804 through IEEE 802.11 (Wi-Fi®) links 828, a cellular network 860 used to communicate with IoT devices 804 through an LTE/LTE-A (4G) or 5G cellular network, and a low-power wide area (LPWA) network 862, for example, a LPWA network compatible with the LoRaWan specification promulgated by the LoRa alliance, or a IPv6 over Low Power Wide-Area Networks (LPWAN) network compatible with a specification promulgated by the Internet Engineering Task Force (IETF). Further, the respective IoT networks may communicate with an outside network provider (e.g., a tier 2 or tier 3 provider) using any number of communications links, such as an LTE cellular link, an LPWA link, or a link based on the IEEE 802.15.4 standard, such as Zigbee®. The respective IoT networks may also operate with use of a variety of network and internet application protocols such as Constrained Application Protocol (CoAP). The respective IoT networks may also be integrated with coordinator devices that provide a chain of links that forms cluster tree of linked devices and networks.

Each of these IoT networks may provide opportunities for new technical features, such as those as described herein. The improved technologies and networks may enable the exponential growth of devices and networks, including the use of IoT networks into “fog” devices or integrated into “Edge” computing systems. As the use of such improved technologies grows, the IoT networks may be developed for self-management, functional evolution, and collaboration, without needing direct human intervention. The improved technologies may even enable IoT networks to function without centralized controlled systems. Accordingly, the improved technologies described herein may be used to automate and enhance network management and operation functions far beyond current implementations.

In an example, communications between IoT devices 804, such as over the backbone links 802, may be protected by a decentralized system for authentication, authorization, and accounting (AAA). In a decentralized AAA system, distributed payment, credit, audit, authorization, and authentication systems may be implemented across interconnected heterogeneous network infrastructure. This allows systems and networks to move towards autonomous operations. In these types of autonomous operations, machines may even contract for human resources and negotiate partnerships with other machine networks. This may allow the achievement of mutual objectives and balanced service delivery against outlined, planned service level agreements as well as achieve solutions that provide metering, measurements, traceability, and trackability. The creation of new supply chain structures and methods may enable a multitude of services to be created, mined for value, and collapsed without any human involvement.

Such IoT networks may be further enhanced by the integration of sensing technologies, such as sound, light, electronic traffic, facial and pattern recognition, smell, vibration, into the autonomous organizations among the IoT devices. The integration of sensory systems may allow systematic and autonomous communication and coordination of service delivery against contractual service objectives, orchestration, and quality of service (QoS) based swarming and fusion of resources. Some of the individual examples of network-based resource processing include the following.

The mesh network 856, for instance, may be enhanced by systems that perform inline data-to-information transforms. For example, self-forming chains of processing resources comprising a multi-link network may distribute the transformation of raw data to information in an efficient manner, and the ability to differentiate between assets and resources and the associated management of each. Furthermore, the proper components of infrastructure and resource-based trust and service indices may be inserted to improve the data integrity, quality, assurance and deliver a metric of data confidence.

The WLAN network 858, for instance, may use systems that perform standards conversion to provide multi-standard connectivity, enabling IoT devices 804 using different protocols to communicate. Further systems may provide seamless interconnectivity across a multi-standard infrastructure comprising visible Internet resources and hidden Internet resources.

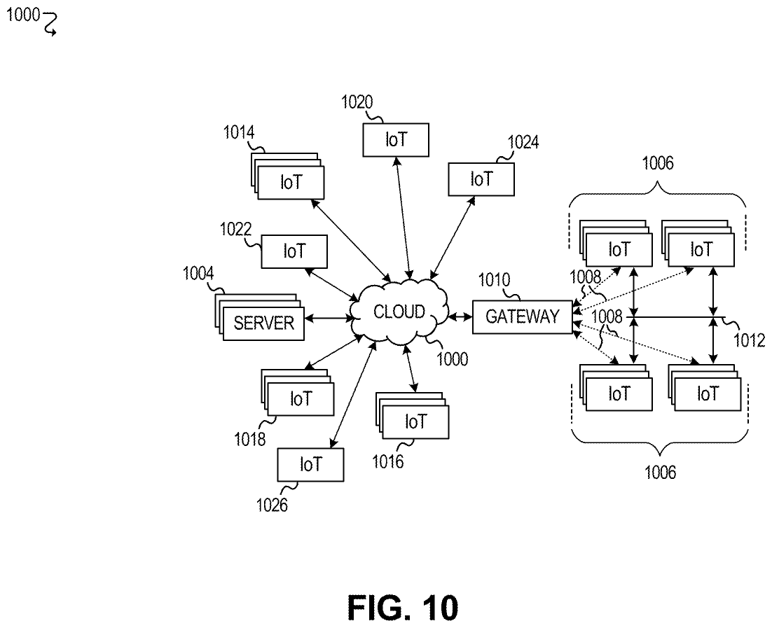

Communications in the cellular network 860, for instance, may be enhanced by systems that offload data, extend communications to more remote devices, or both. The LPWA network 862 may include systems that perform non-Internet protocol (IP) to IP interconnections, addressing, and routing. Further, each of the IoT devices 804 may include the appropriate transceiver for wide area communications with that device. Further, each IoT device 804 may include other transceivers for communications using additional protocols and frequencies. This is discussed further with respect to the communication environment and hardware of an IoT processing device depicted in FIGS. 10 and 11.

Finally, clusters of IoT devices may be equipped to communicate with other IoT devices as well as with a cloud network. This may allow the IoT devices to form an ad-hoc network between the devices, allowing them to function as a single device, which may be termed a fog device, fog platform, or fog network. This configuration is discussed further with respect to FIG. 9 below.

FIG. 9 illustrates a cloud computing network in communication with a mesh network of IoT devices (devices 902) operating as a fog platform in a networked scenario. The mesh network of IoT devices may be termed a fog network 920, established from a network of devices operating at the Edge of the cloud 900. To simplify the diagram, not every IoT device 902 is labeled.

The fog network 920 may be considered to be a massively interconnected network wherein a number of IoT devices 902 are in communications with each other, for example, by radio links 922. The fog network 920 may establish a horizontal, physical, or virtual resource platform that can be considered to reside between IoT Edge devices and cloud or data centers. A fog network, in some examples, may support vertically isolated, latency-sensitive applications through layered, federated, or distributed computing, storage, and network connectivity operations. However, a fog network may also be used to distribute resources and services at and among the Edge and the cloud. Thus, references in the present document to the “Edge”, “fog”, and “cloud” are not necessarily discrete or exclusive of one another.

As an example, the fog network 920 may be facilitated using an interconnect specification released by the Open Connectivity Foundation™ (OCF). This standard allows devices to discover each other and establish communications for interconnects. Other interconnection protocols may also be used, including, for example, the optimized link state routing (OLSR) Protocol, the better approach to mobile ad-hoc networking (B.A.T.M.A.N.) routing protocol, or the OMA Lightweight M2M (LWM2M) protocol, among others.

Three types of IoT devices 902 are shown in this example, gateways 904, data aggregators 926, and sensors 928, although any combinations of IoT devices 902 and functionality may be used. The gateways 904 may be Edge devices that provide communications between the cloud 900 and the fog network 920, and may also provide the backend process function for data obtained from sensors 928, such as motion data, flow data, temperature data, and the like. The data aggregators 926 may collect data from any number of the sensors 928 and perform the back end processing function for the analysis. The results, raw data, or both may be passed along to the cloud 900 through the gateways 904. The sensors 928 may be full IoT devices 902, for example, capable of both collecting data and processing the data. In some cases, the sensors 928 may be more limited in functionality, for example, collecting the data and allowing the data aggregators 926 or gateways 904 to process the data.

Communications from any IoT device 902 may be passed along a convenient path between any of the IoT devices 902 to reach the gateways 904. In these networks, the number of interconnections provide substantial redundancy, allowing communications to be maintained, even with the loss of a number of IoT devices 902. Further, the use of a mesh network may allow IoT devices 902 that are very low power or located at a distance from infrastructure to be used, as the range to connect to another IoT device 902 may be much less than the range to connect to the gateways 904.

The fog network 920 provided from these IoT devices 902 may be presented to devices in the cloud 900, such as a server 906, as a single device located at the Edge of the cloud 900, e.g., a fog network operating as a device or platform. In this example, the alerts coming from the fog platform may be sent without being identified as coming from a specific IoT device 902 within the fog network 920. In this fashion, the fog network 920 may be considered a distributed platform that provides computing and storage resources to perform processing or data-intensive tasks such as data analytics, data aggregation, and machine-learning, among others.

In some examples, the IoT devices 902 may be configured using an imperative programming style, e.g., with each IoT device 902 having a specific function and communication partners. However, the IoT devices 902 forming the fog platform may be configured in a declarative programming style, enabling the IoT devices 902 to reconfigure their operations and communications, such as to determine needed resources in response to conditions, queries, and device failures. As an example, a query from a user located at a server 906 about the operations of a subset of equipment monitored by the IoT devices 902 may result in the fog network 920 device the IoT devices 902, such as particular sensors 928, needed to answer the query. The data from these sensors 928 may then be aggregated and analyzed by any combination of the sensors 928, data aggregators 926, or gateways 904, before being sent on by the fog network 920 to the server 906 to answer the query. In this example, IoT devices 902 in the fog network 920 may select the sensors 928 used based on the query, such as adding data from flow sensors or temperature sensors. Further, if some of the IoT devices 902 are not operational, other IoT devices 902 in the fog network 920 may provide analogous data, if available.

In other examples, the operations and functionality described herein may be embodied by an IoT or Edge compute device in the example form of an electronic processing system, within which a set or sequence of instructions may be executed to cause the electronic processing system to perform any one of the methodologies discussed herein, according to an example embodiment. The device may be an IoT device or an IoT gateway, including a machine embodied by aspects of a personal computer (PC), a tablet PC, a personal digital assistant (PDA), a mobile telephone or smartphone, or any machine capable of executing instructions (sequential or otherwise) that specify actions to be taken by that machine.

Further, while only a single machine may be depicted and referenced in the examples above, such machine shall also be taken to include any collection of machines that individually or jointly execute a set (or multiple sets) of instructions to perform any one or more of the methodologies discussed herein. Further, these and like examples to a processor-based system shall be taken to include any set of one or more machines that are controlled by or operated by a processor, set of processors, or processing circuitry (e.g., a computer) to individually or jointly execute instructions to perform any one or more of the methodologies discussed herein. Accordingly, in various examples, applicable means for processing (e.g., processing, controlling, generating, evaluating, etc.) may be embodied by such processing circuitry.

FIG. 10 illustrates a drawing of a cloud computing network, or cloud 1000, in communication with a number of Internet of Things (IoT) devices. The cloud 1000 may represent the Internet or may be a local area network (LAN), or a wide area network (WAN), such as a proprietary network for a company. The IoT devices may include any number of different types of devices, grouped in various combinations. For example, a traffic control group 1006 may include IoT devices along streets in a city. These IoT devices may include stoplights, traffic flow monitors, cameras, weather sensors, and the like. The traffic control group 1006, or other subgroups, may be in communication with the cloud 1000 through wired or wireless links 1008, such as LPWA links, and the like. Further, a wired or wireless sub-network 1012 may allow the IoT devices to communicate with each other, such as through a local area network, a wireless local area network, and the like. The IoT devices may use another device, such as a gateway 1010 or 1028 to communicate with remote locations such as the cloud 1000; the IoT devices may also use one or more servers 1030 to facilitate communication with the cloud 1000 or with the gateway 1010. For example, the one or more servers 1030 may operate as an intermediate network node to support a local Edge cloud or fog implementation among a local area network. Further, the gateway 1028 that is depicted may operate in a cloud-to-gateway-to-many Edge devices configuration, such as with the various IoT devices 1014, 1020, 1024 being constrained or dynamic to an assignment and use of resources in the cloud 1000.

Other example groups of IoT devices may include remote weather stations 1014, local information terminals 1016, alarm systems 1018, automated teller machines 1020, alarm panels 1022, or moving vehicles, such as emergency vehicles 1024 or other vehicles 1026, among many others. Each of these IoT devices may be in communication with other IoT devices, with servers 1004, with another IoT fog device or system (not shown but depicted in FIG. 9), or a combination therein. The groups of IoT devices may be deployed in various residential, commercial, and industrial settings (including in both private and public environments).

As may be seen from FIG. 10, a large number of IoT devices may be communicating through the cloud 1000. This may allow different IoT devices to request or provide information to other devices autonomously. For example, a group of IoT devices (e.g., the traffic control group 1006) may request a current weather forecast from a group of remote weather stations 1014, which may provide the forecast without human intervention. Further, an emergency vehicle 1024 may be alerted by an automated teller machine 1020 that a burglary is in progress. As the emergency vehicle 1024 proceeds towards the automated teller machine 1020, it may access the traffic control group 1006 to request clearance to the location, for example, by lights turning red to block cross traffic at an intersection in sufficient time for the emergency vehicle 1024 to have unimpeded access to the intersection.

Clusters of IoT devices, such as the remote weather stations 1014 or the traffic control group 1006, may be equipped to communicate with other IoT devices as well as with the cloud 1000. This may allow the IoT devices to form an ad-hoc network between the devices, allowing them to function as a single device, which may be termed a fog device or system (e.g., as described above with reference to FIG. 9).

FIG. 11 is a block diagram of an example environment 1100 of components that may be present in an IoT device 1150 for implementing the techniques described herein. The IoT device 1150 may include any combinations of the components shown in the example or referenced in the disclosure above. The components may be implemented as ICs, portions thereof, discrete electronic devices, or other modules, logic, hardware, software, firmware, or a combination thereof adapted in the IoT device 1150, or as components otherwise incorporated within a chassis of a larger system. Additionally, the block diagram of FIG. 11 is intended to depict a high-level view of components of the IoT device 1150. However, some of the components shown may be omitted, additional components may be present, and different arrangement of the components shown may occur in other implementations.

The IoT device 1150 may include processor circuitry in the form of, for example, a processor 1152, which may be a microprocessor, a multi-core processor, a multithreaded processor, an ultra-low voltage processor, an embedded processor, or other known processing elements. The processor 1152 may be a part of a system on a chip (SoC) in which the processor 1152 and other components are formed into a single integrated circuit, or a single package, such as the Edison™ or Galileo™ SoC boards from Intel. As an example, the processor 1152 may include an Intel® Architecture Core™ based processor, such as a Quark™, an Atom™, an i3, an i5, an i7, or an MCU-class processor, or another such processor available from Intel® Corporation, Santa Clara, Calif. However, any number other processors may be used, such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd., or customer thereof, or their licensees or adopters. The processors may include units such as an A5-A14 processor from Apple® Inc., a Snapdragon™ processor from Qualcomm® Technologies, Inc., or an OMAP™ processor from Texas Instruments, Inc.

The processor 1152 may communicate with a system memory 1154 over an interconnect 1156 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In various implementations the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 1158 may also couple to the processor 1152 via the interconnect 1156. In an example the storage 1158 may be implemented via a solid-state disk drive (SSDD). Other devices that may be used for the storage 1158 include flash memory cards, such as SD cards, microSD cards, xD picture cards, and the like, and USB flash drives. In low power implementations, the storage 1158 may be on-die memory or registers associated with the processor 1152. However, in some examples, the storage 1158 may be implemented using a micro hard disk drive (HDD). Further, any number of new technologies may be used for the storage 1158 in addition to, or instead of, the technologies described, such resistance change memories, phase change memories, holographic memories, or chemical memories, among others.

The components may communicate over the interconnect 1156. The interconnect 1156 may include any number of technologies, including industry standard architecture (ISA), extended ISA (EISA), peripheral component interconnect (PCI), peripheral component interconnect extended (PCIx), PCI express (PCIe), or any number of other technologies. The interconnect 1156 may be a proprietary bus, for example, used in a SoC based system. Other bus systems may be included, such as an I2C interface, an SPI interface, point to point interfaces, and a power bus, among others.

Given the variety of types of applicable communications from the device to another component or network, applicable communications circuitry used by the device may include or be embodied by any one or more of components 1162, 1166, 1168, or 1170. Accordingly, in various examples, applicable means for communicating (e.g., receiving, transmitting, etc.) may be embodied by such communications circuitry.

The interconnect 1156 may couple the processor 1152 to a mesh transceiver 1162, for communications with other mesh devices 1164. The mesh transceiver 1162 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the mesh devices 1164. For example, a WLAN unit may be used to implement Wi-Fi™ communications in accordance with the Institute of Electrical and Electronics Engineers (IEEE) 802.11 standard. In addition, wireless wide area communications, e.g., according to a cellular or other wireless wide area protocol, may occur via a WWAN unit.

The mesh transceiver 1162 may communicate using multiple standards or radios for communications at different range. For example, the IoT device 1150 may communicate with close devices, e.g., within about 10 meters, using a local transceiver based on BLE, or another low power radio, to save power. More distant mesh devices 1164, e.g., within about 50 meters, may be reached over ZigBee or other intermediate power radios. Both communications techniques may take place over a single radio at different power levels, or may take place over separate transceivers, for example, a local transceiver using BLE and a separate mesh transceiver using ZigBee.

A wireless network transceiver 1166 may be included to communicate with devices or services in the cloud 1101 via local or wide area network protocols. The wireless network transceiver 1166 may be a LPWA transceiver that follows the IEEE 802.15.4, or IEEE 802.15.4g standards, among others. The IoT device 1150 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the mesh transceiver 1162 and wireless network transceiver 1166, as described herein. For example, the radio transceivers 1162 and 1166 may include an LTE or other cellular transceiver that uses spread spectrum (SPA/SAS) communications for implementing high speed communications. Further, any number of other protocols may be used, such as Wi-Fi® networks for medium speed communications and provision of network communications.

The radio transceivers 1162 and 1166 may include radios that are compatible with any number of 3GPP (Third Generation Partnership Project) specifications, notably Long Term Evolution (LTE), Long Term Evolution-Advanced (LTE-A), and Long Term Evolution-Advanced Pro (LTE-A Pro). It may be noted that radios compatible with any number of other fixed, mobile, or satellite communication technologies and standards may be selected. These may include, for example, any Cellular Wide Area radio communication technology, which may include e.g. a 5th Generation (5G) communication systems, a Global System for Mobile Communications (GSM) radio communication technology, a General Packet Radio Service (GPRS) radio communication technology, or an Enhanced Data Rates for GSM Evolution (EDGE) radio communication technology, a UMTS (Universal Mobile Telecommunications System) communication technology, In addition to the standards listed above, any number of satellite uplink technologies may be used for the wireless network transceiver 1166, including, for example, radios compliant with standards issued by the ITU (International Telecommunication Union), or the ETSI (European Telecommunications Standards Institute), among others. The examples provided herein are thus understood as being applicable to various other communication technologies, both existing and not yet formulated.

A network interface controller (NIC) 1168 or other similar communications circuitry may be included to provide a wired communication to the cloud 1101 or to other devices, such as the mesh devices 1164. The wired communication may provide an Ethernet connection, or may be based on other types of networks, such as Controller Area Network (CAN), Local Interconnect Network (LIN), DeviceNet, ControlNet, Data Highway+, PROFIBUS, or PROFINET, among many others. An additional NIC 1168 may be included to allow connect to a second network, for example, a NIC 1168 providing communications to the cloud over Ethernet, and a second NIC 1168 providing communications to other devices over another type of network.

The interconnect 1156 may couple the processor 1152 to an external interface 1170 that is used to connect external devices or subsystems. The external devices may include sensors 1172, such as accelerometers, level sensors, flow sensors, optical light sensors, camera sensors, temperature sensors, a global positioning system (GPS) sensors, pressure sensors, barometric pressure sensors, and the like. The external interface 1170 further may be used to connect the IoT device 1150 to actuators 1174, such as power switches, valve actuators, an audible sound generator, a visual warning device, and the like.

In some optional examples, various input/output (I/O) devices may be present within, or connected to, the IoT device 1150. For example, a display or other output device 1184 may be included to show information, such as sensor readings or actuator position. An input device 1186, such as a touch screen or keypad may be included to accept input. An output device 1186 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the IoT device 1150.

A battery 1176 may power the IoT device 1150, although in examples in which the IoT device 1150 is mounted in a fixed location, it may have a power supply coupled to an electrical grid. The battery 1176 may be a lithium-ion battery, or a metal-air battery, such as a zinc-air battery, an aluminum-air battery, a lithium-air battery, and the like.

A battery monitor/charger 1178 may be included in the IoT device 1150 to track the state of charge (SoCh) of the battery 1176. The battery monitor/charger 1178 may be used to monitor other parameters of the battery 1176 to provide failure predictions, such as the state of health (SoH) and the state of function (SoF) of the battery 1176. The battery monitor/charger 1178 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 1178 may communicate the information on the battery 1176 to the processor 1152 over the interconnect 1156. The battery monitor/charger 1178 may also include an analog-to-digital (ADC) convertor that allows the processor 1152 to directly monitor the voltage of the battery 1176 or the current flow from the battery 1176. The battery parameters may be used to determine actions that the IoT device 1150 may perform, such as transmission frequency, mesh network operation, sensing frequency, and the like.

A power block 1180, or other power supply coupled to a grid, may be coupled with the battery monitor/charger 1178 to charge the battery 1176. In some examples, the power block 1180 may be replaced with a wireless power receiver to obtain the power wirelessly, for example, through a loop antenna in the IoT device 1150. A wireless battery charging circuit, such as an LTC4020 chip from Linear Technologies of Milpitas, Calif., among others, may be included in the battery monitor/charger 1178. The specific charging circuits chosen depend on the size of the battery 1176, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1158 may include instructions 1182 in the form of software, firmware, or hardware commands to implement the techniques described herein. Although such instructions 1182 are shown as code blocks included in the memory 1154 and the storage 1158, it may be understood that any of the code blocks may be replaced with hardwired circuits, for example, built into an application specific integrated circuit (ASIC).

In an example, the instructions 1182 provided via the memory 1154, the storage 1158, or the processor 1152 may be embodied as a non-transitory, machine readable medium 1160 including code to direct the processor 1152 to perform electronic operations in the IoT device 1150. The processor 1152 may access the non-transitory, machine readable medium 1160 over the interconnect 1156. For instance, the non-transitory, machine readable medium 1160 may be embodied by devices described for the storage 1158 of FIG. 11 or may include specific storage units such as optical disks, flash drives, or any number of other hardware devices. The non-transitory, machine readable medium 1160 may include instructions to direct the processor 1152 to perform a specific sequence or flow of actions, for example, as described with respect to the flowchart(s) and block diagram(s) of operations and functionality depicted above.

Also in a specific example, the instructions 1188 on the processor 1152 (separately, or in combination with the instructions 1188 of the machine readable medium 1160) may configure execution or operation of a trusted execution environment (TEE) 1190. In an example, the TEE 1190 operates as a protected area accessible to the processor 1152 for secure execution of instructions and secure access to data. Various implementations of the TEE 1190, and an accompanying secure area in the processor 1152 or the memory 1154 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 1150 through the TEE 1190 and the processor 1152.

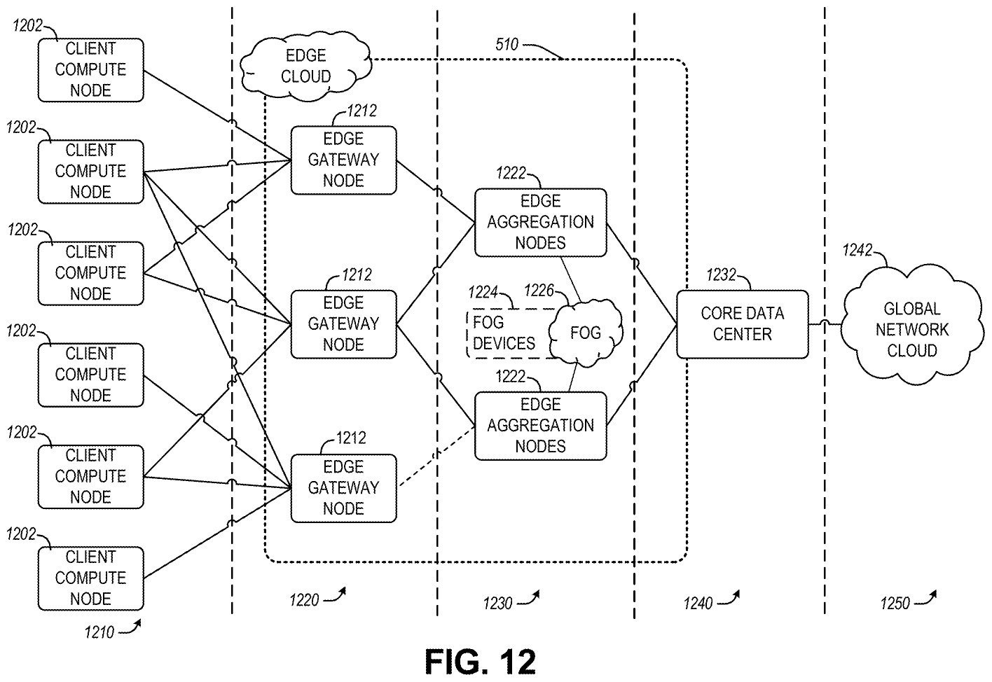

At a more generic level, an Edge computing system may be described to encompass any number of deployments operating in an Edge cloud 510, which provide coordination from client and distributed computing devices. FIG. 12 provides a further abstracted overview of layers of distributed compute deployed among an Edge computing environment for purposes of illustration.

FIG. 12 generically depicts an Edge computing system for providing Edge services and applications to multi-stakeholder entities, as distributed among one or more client compute nodes 1202, one or more Edge gateway nodes 1212, one or more Edge aggregation nodes 1222, one or more core data centers 1232, and a global network cloud 1242, as distributed across layers of the network. The implementation of the Edge computing system may be provided at or on behalf of a telecommunication service provider (“telco”, or “TSP”), internet-of-things service provider, cloud service provider (CSP), enterprise entity, or any other number of entities.

Each node or device of the Edge computing system is located at a particular layer corresponding to layers 1210, 1220, 1230, 1240, 1250. For example, the client compute nodes 1202 are each located at an endpoint layer 1210, while each of the Edge gateway nodes 1212 are located at an Edge devices layer 1220 (local level) of the Edge computing system. Additionally, each of the Edge aggregation nodes 1222 (and/or fog devices 1224, if arranged or operated with or among a fog networking configuration 1226) are located at a network access layer 1230 (an intermediate level). Fog computing (or “fogging”) generally refers to extensions of cloud computing to the Edge of an enterprise's network, typically in a coordinated distributed or multi-node network. Some forms of fog computing provide the deployment of compute, storage, and networking services between end devices and cloud computing data centers, on behalf of the cloud computing locations. Such forms of fog computing provide operations that are consistent with Edge computing as discussed herein; many of the Edge computing aspects discussed herein are applicable to fog networks, fogging, and fog configurations. Further, aspects of the Edge computing systems discussed herein may be configured as a fog, or aspects of a fog may be integrated into an Edge computing architecture.

The core data center 1232 is located at a core network layer 1240 (e.g., a regional or geographically-central level), while the global network cloud 1242 is located at a cloud data center layer 1250 (e.g., a national or global layer). The use of “core” is provided as a term for a centralized network location—deeper in the network—which is accessible by multiple Edge nodes or components; however, a “core” does not necessarily designate the “center” or the deepest location of the network. Accordingly, the core data center 1232 may be located within, at, or near the Edge cloud 510.

Although an illustrative number of client compute nodes 1202, Edge gateway nodes 1212, Edge aggregation nodes 1222, core data centers 1232, global network clouds 1242 are shown in FIG. 12, it should be appreciated that the Edge computing system may include more or fewer devices or systems at each layer. Additionally, as shown in FIG. 12, the number of components of each layer 1210, 1220, 1230, 1240, 1250 generally increases at each lower level (i.e., when moving closer to endpoints). As such, one Edge gateway node 1212 may service multiple client compute nodes 1202, and one Edge aggregation node 1222 may service multiple Edge gateway nodes 1212.

Consistent with the examples provided herein, each client compute node 1202 may be embodied as any type of end point component, device, appliance, or “thing” capable of communicating as a producer or consumer of data. Further, the label “node” or “device” as used in the Edge computing system 1200 does not necessarily mean that such node or device operates in a client or agent/minion/follower role; rather, any of the nodes or devices in the Edge computing system 1200 refer to individual entities, nodes, or subsystems which include discrete or connected hardware or software configurations to facilitate or use the Edge cloud 510.

As such, the Edge cloud 510 is formed from network components and functional features operated by and within the Edge gateway nodes 1212 and the Edge aggregation nodes 1222 of layers 1220, 1230, respectively. The Edge cloud 510 may be embodied as any type of network that provides Edge computing and/or storage resources which are proximately located to radio access network (RAN) capable endpoint devices (e.g., mobile computing devices, IoT devices, smart devices, etc.), which are shown in FIG. 12 as the client compute nodes 1202. In other words, the Edge cloud 510 may be envisioned as an “Edge” which connects the endpoint devices and traditional mobile network access points that serves as an ingress point into service provider core networks, including carrier networks (e.g., Global System for Mobile Communications (GSM) networks, Long-Term Evolution (LTE) networks, 5G networks, etc.), while also providing storage and/or compute capabilities. Other types and forms of network access (e.g., Wi-Fi, long-range wireless networks) may also be utilized in place of or in combination with such 3GPP carrier networks.

In some examples, the Edge cloud 510 may form a portion of or otherwise provide an ingress point into or across a fog networking configuration 1226 (e.g., a network of fog devices 1224, not shown in detail), which may be embodied as a system-level horizontal and distributed architecture that distributes resources and services to perform a specific function. For instance, a coordinated and distributed network of fog devices 1224 may perform computing, storage, control, or networking aspects in the context of an IoT system arrangement. Other networked, aggregated, and distributed functions may exist in the Edge cloud 510 between the cloud data center layer 1250 and the client endpoints (e.g., client compute nodes 1202). Some of these are discussed in the following sections in the context of network functions or service virtualization, including the use of virtual Edges and virtual services which are orchestrated for multiple stakeholders.

The Edge gateway nodes 1212 and the Edge aggregation nodes 1222 cooperate to provide various Edge services and security to the client compute nodes 1202. Furthermore, because each client compute node 1202 may be stationary or mobile, each Edge gateway node 1212 may cooperate with other Edge gateway devices to propagate presently provided Edge services and security as the corresponding client compute node 1202 moves about a region. To do so, each of the Edge gateway nodes 1212 and/or Edge aggregation nodes 1222 may support multiple tenancy and multiple stakeholder configurations, in which services from (or hosted for) multiple service providers and multiple consumers may be supported and coordinated across a single or multiple compute devices.

### Computing Devices and Systems

In further examples, any of the compute nodes or devices discussed with reference to the present edge computing systems and environment may be fulfilled based on the components depicted in FIGS. 13A and 13B. Respective edge compute nodes may be embodied as a type of device, appliance, computer, or other “thing” capable of communicating with other edge, networking, or endpoint components. For example, an edge compute device may be embodied as a personal computer, server, smartphone, a mobile compute device, a smart appliance, smart camera, an in-vehicle compute system (e.g., a navigation system), a weatherproof computing appliance, a self-contained device within an outer case, shell, etc., that may be weatherproof or weather-sealed, or other device or system capable of performing the described functions.

In the simplified example depicted in FIG. 13A, an edge compute node 1300 includes a compute engine (also referred to herein as “compute circuitry”) 1302, an input/output (I/O) subsystem 1308, data storage 1310, a communication circuitry subsystem 1312, and, optionally, one or more peripheral devices 1314. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 1300 may be embodied as any type of engine, device, or collection of devices capable of performing various compute functions. In some examples, the compute node 1300 may be embodied as a single device such as an integrated circuit, an embedded system, a field-programmable gate array (FPGA), a system-on-a-chip (SOC), or other integrated system or device. In the illustrative example, the compute node 1300 includes or is embodied as a processor 1304 and a memory 1306. The processor 1304 may be embodied as any type of processor capable of performing the functions described herein (e.g., executing an application). For example, the processor 1304 may be embodied as a multi-core processor(s), a microcontroller, a processing unit, a specialized or special purpose processing unit, or other processor or processing/controlling circuit.

In some examples, the processor 1304 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 1304 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing, or managing server or data center hardware, managing service meshes, or collecting and distributing telemetry), outside of the CPU or general-purpose processing hardware. However, it will be understood that a xPU, a SOC, a CPU, and other variations of the processor 1304 may work in coordination with each other to execute many types of operations and instructions within and on behalf of the compute node 1300.

The memory 1306 may be embodied as any type of volatile (e.g., dynamic random-access memory (DRAM), etc.) or non-volatile memory or data storage capable of performing the functions described herein. Volatile memory may be a storage medium that requires power to maintain the state of data stored by the medium. Non-limiting examples of volatile memory may include various types of random-access memory (RAM), such as DRAM or static random-access memory (SRAM). One particular type of DRAM that may be used in a memory module is synchronous dynamic random-access memory (SDRAM).

In an example, the memory device is a block addressable memory device, such as those based on NAND or NOR technologies. A memory device may also include a three-dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory 1306 may be integrated into the processor 1304. The memory 1306 may store various software and data used during operation such as one or more applications, data operated on by the application(s), libraries, and drivers.

The compute circuitry 1302 is communicatively coupled to other components of the compute node 1300 via the I/O subsystem 1308, which may be embodied as circuitry and/or components to facilitate input/output operations with the compute circuitry 1302 (e.g., with the processor 1304 and/or the main memory 1306) and other components of the compute circuitry 1302. For example, the I/O subsystem 1308 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 1308 may form a portion of a system-on-a-chip (SoC) and be incorporated, along with one or more of the processor 1304, the memory 1306, and other components of the compute circuitry 1302, into the compute circuitry 1302.

The one or more illustrative data storage devices 1310 may be embodied as any type of devices configured for short-term or long-term storage of data such as, for example, memory devices and circuits, memory cards, hard disk drives, solid-state drives, or other data storage devices. Individual data storage devices 1310 may include a system partition that stores data and firmware code for the data storage device 1310. Individual data storage devices 1310 may also include one or more operating system partitions that store data files and executables for operating systems depending on, for example, the type of compute node 1300.

The communication circuitry 1312 may be embodied as any communication circuit, device, or collection thereof, capable of enabling communications over a network between the compute circuitry 1302 and another compute device (e.g., an edge gateway of an implementing edge computing system). The communication circuitry 1312 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 1312 includes a network interface controller (NIC) 1320, which may also be referred to as a host fabric interface (HFI). The NIC 1320 may be embodied as one or more add-in-boards, daughter cards, network interface cards, controller chips, chipsets, or other devices that may be used by the compute node 1300 to connect with another compute device (e.g., an edge gateway node). In some examples, the NIC 1320 may be embodied as part of a system-on-a-chip (SoC) that includes one or more processors or included on a multichip package that also contains one or more processors. In some examples, the NIC 1320 may include a local processor (not shown) and/or a local memory (not shown) that are both local to the NIC 1320. In such examples, the local processor of the NIC 1320 may be capable of performing one or more of the functions of the compute circuitry 1302 described herein. Additionally, or alternatively, in such examples, the local memory of the NIC 1320 may be integrated into one or more components of the client compute node at the board level, socket level, chip level, and/or other levels.

Additionally, in some examples, a respective compute node 1300 may include one or more peripheral devices 1314. Such peripheral devices 1314 may include any type of peripheral device found in a compute device or server such as audio input devices, a display, other input/output devices, interface devices, and/or other peripheral devices, depending on the particular type of the compute node 1300. In further examples, the compute node 1300 may be embodied by a respective edge compute node (whether a client, gateway, or aggregation node) in an edge computing system or like forms of appliances, computers, subsystems, circuitry, or other components.

In a more detailed example, FIG. 13B illustrates a block diagram of an example of components that may be present in an edge computing node 1350 for implementing the techniques (e.g., operations, processes, methods, and methodologies) described herein. This edge computing node 1350 provides a closer view of the respective components of node 1300 when implemented as or as part of a computing device (e.g., as a mobile device, a base station, server, gateway, etc.). The edge computing node 1350 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 1350, or as components otherwise incorporated within a chassis of a larger system.

The edge computing device 1350 may include processing circuitry in the form of a processor 1352, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 1352 may be a part of a system on a chip (SoC) in which the processor 1352 and other components are formed into a single integrated circuit, or a single package, such as the Edison™ or Galileo™ SoC boards from Intel Corporation, Santa Clara, Calif. As an example, the processor 1352 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, Calif., a MIPS®-based design from MIPS Technologies, Inc. of Sunnyvale, Calif., an ARM®-based design licensed from ARM Holdings, Ltd., or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 1352 and accompanying circuitry may be provided in a single socket form factor, multiple socket form factor, or a variety of other formats, including in limited hardware configurations or configurations that include fewer than all elements shown in FIG. 13B.

The processor 1352 may communicate with a system memory 1354 over an interconnect 1356 (e.g., a bus). Any number of memory devices may be used to provide for a given amount of system memory. As examples, the memory 754 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 1358 may also couple to the processor 1352 via the interconnect 1356. In an example, the storage 1358 may be implemented via a solid-state disk drive (SSDD). Other devices that may be used for the storage 1358 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 1358 may be on-die memory or registers associated with the processor 1352. However, in some examples, the storage 1358 may be implemented using a micro hard disk drive (HDD). Further, any number of new technologies may be used for the storage 1358 in addition to, or instead of, the technologies described, such resistance change memories, phase change memories, holographic memories, or chemical memories, among others.

The components may communicate over the interconnect 156. The interconnect 1356 may include any number of technologies, including industry standard architecture (ISA), extended ISA (EISA), peripheral component interconnect (PCI), peripheral component interconnect extended (PCIx), PCI express (PCIe), or any number of other technologies. The interconnect 1356 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 1356 may couple the processor 1352 to a communications controller or transceiver 1366, for communications with the connected edge devices 1362. The transceiver 1366 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 1362. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 1366 (or multiple transceivers) may communicate using multiple standards or radios for communications at a different range. For example, the edge computing node 1350 may communicate with close devices, e.g., within about 10 meters, using a local transceiver based on Bluetooth Low Energy (BLE), or another low power radio, to save power. More distant connected edge devices 1362, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 1366 (e.g., a radio transceiver) may be included to communicate with devices or services in a cloud (e.g., an edge cloud 1395) via local or wide area network protocols. The wireless network transceiver 166 may be a low-power wide-area (LPWA) transceiver that follows the IEEE 802.15.4, or IEEE 802.15.4g standards, among others. The edge computing node 1350 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 1366, as described herein. For example, the transceiver 1366 may include a cellular transceiver that uses spread spectrum (SPA/SAS) communications for implementing high-speed communications. Further, any number of other protocols may be used, such as Wi-Fi® networks for medium speed communications and provision of network communications. The transceiver 1366 may include radios that are compatible with any number of 3GPP (Third Generation Partnership Project) specifications, such as Long-Term Evolution (LTE) and 5th Generation (5G) communication systems, discussed in further detail at the end of the present disclosure. A network interface controller (NIC) 1368 may be included to provide a wired communication to nodes of the edge cloud 1395 or to other devices, such as the connected edge devices 1362 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 1368 may be included to enable connecting to a second network, for example, a first NIC 1368 providing communications to the cloud over Ethernet, and a second NIC 1368 providing communications to other devices over another type of network.

Given the variety of types of applicable communications from the device to another component or network, applicable communications circuitry used by the device may include or be embodied by any one or more of components 1364, 1366, 168, or 1370. Accordingly, in various examples, applicable means for communicating (e.g., receiving, transmitting, etc.) may be embodied by such communications circuitry.

The edge computing node 1350 may include or be coupled to acceleration circuitry 1364, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific edge computing tasks for service management and service operations discussed elsewhere in this document.

The interconnect 1356 may couple the processor 1352 to a sensor hub or external interface 1370 that is used to connect additional devices or subsystems. The devices may include sensors 1372, such as accelerometers, level sensors, flow sensors, optical light sensors, camera sensors, temperature sensors, global navigation system (e.g., GPS) sensors, pressure sensors, barometric pressure sensors, and the like. The hub or interface 1370 further may be used to connect the edge computing node 1350 to actuators 1374, such as power switches, valve actuators, an audible sound generator, a visual warning device, and the like.

In some optional examples, various input/output (I/O) devices may be present within or connected to, the edge computing node 1350. For example, a display or other output device 1384 may be included to show information, such as sensor readings or actuator position. An input device 1386, such as a touch screen or keypad may be included to accept input. An output device 1384 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 1350. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 1376 may power the edge computing node 1350, although, in examples in which the edge computing node 1350 is mounted in a fixed location, it may have a power supply coupled to an electrical grid, or the battery may be used as a backup or for temporary capabilities. The battery 1376 may be a lithium-ion battery, or a metal-air battery, such as a zinc-air battery, an aluminum-air battery, a lithium-air battery, and the like.

A battery monitor/charger 1378 may be included in the edge computing node 150 to track the state of charge (SoCh) of the battery 1376, if included. The battery monitor/charger 1378 may be used to monitor other parameters of the battery 1376 to provide failure predictions, such as the state of health (SoH) and the state of function (SoF) of the battery 1376. The battery monitor/charger 1378 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 1378 may communicate the information on the battery 1376 to the processor 1352 over the interconnect 1356. The battery monitor/charger 1378 may also include an analog-to-digital (ADC) converter that enables the processor 1352 to directly monitor the voltage of the battery 1376 or the current flow from the battery 1376. The battery parameters may be used to determine actions that the edge computing node 1350 may perform, such as transmission frequency, mesh network operation, sensing frequency, and the like.

A power block 1380, or other power supply coupled to a grid, may be coupled with the battery monitor/charger 1378 to charge the battery 1376. In some examples, the power block 1380 may be replaced with a wireless power receiver to obtain the power wirelessly, for example, through a loop antenna in the edge computing node 1350. A wireless battery charging circuit, such as an LTC4020 chip from Linear Technologies of Milpitas, Calif., among others, may be included in the battery monitor/charger 1378. The specific charging circuits may be selected based on the size of the battery 1376, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1358 may include instructions 1382 in the form of software, firmware, or hardware commands to implement the techniques described herein. Although such instructions 1382 are shown as code blocks included in the memory 1354 and the storage 1358, it may be understood that any of the code blocks may be replaced with hardwired circuits, for example, built into an application specific integrated circuit (ASIC).

In an example, the instructions 1382 provided via the memory 1354, the storage 1358, or the processor 1352 may be embodied as a non-transitory, machine-readable medium 1360 including code to direct the processor 1352 to perform electronic operations in the edge computing node 1350. The processor 1352 may access the non-transitory, machine-readable medium 1360 over the interconnect 1356. For instance, the non-transitory, machine-readable medium 1360 may be embodied by devices described for the storage 1358 or may include specific storage units such as optical disks, flash drives, or any number of other hardware devices. The non-transitory, machine-readable medium 1360 may include instructions to direct the processor 1352 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 1382 on the processor 1352 (separately, or in combination with the instructions 1382 of the machine readable medium 1360) may configure execution or operation of a trusted execution environment (TEE) 190. In an example, the TEE 190 operates as a protected area accessible to the processor 152 for secure execution of instructions and secure access to data. Various implementations of the TEE 190, and an accompanying secure area in the processor 1352 or the memory 1354 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 1350 through the TEE 190 and the processor 1352.

### Machine-Readable Medium and Distributed Software Instructions

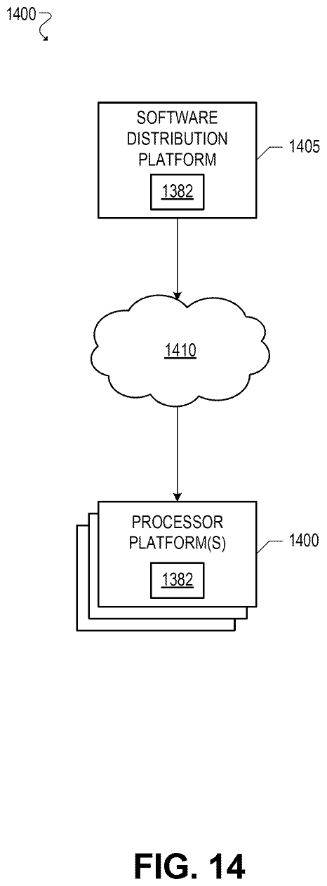

FIG. 14 illustrates an example software distribution platform 1405 to distribute software, such as the example computer readable instructions 1382 of FIG. 13B, to one or more devices, such as example processor platform(s) 1400 and/or example connected edge devices described throughout this disclosure. The example software distribution platform 1405 may be implemented by any computer server, data facility, cloud service, etc., capable of storing and transmitting software to other computing devices (e.g., third parties, example connected edge devices described throughout this disclosure). Example connected edge devices may be customers, clients, managing devices (e.g., servers), third parties (e.g., customers of an entity owning and/or operating the software distribution platform 1405). Example connected edge devices may operate in commercial and/or home automation environments. In some examples, a third party is a developer, a seller, and/or a licensor of software such as the example computer readable instructions 1382 of FIG. 13B. The third parties may be consumers, users, retailers, OEMs, etc. that purchase and/or license the software for use and/or re-sale and/or sub-licensing. In some examples, distributed software causes display of one or more user interfaces (UIs) and/or graphical user interfaces (GUIs) to identify the one or more devices (e.g., connected edge devices) geographically and/or logically separated from each other (e.g., physically separated IoT devices chartered with the responsibility of water distribution control (e.g., pumps), electricity distribution control (e.g., relays), etc.).

In the illustrated example of FIG. 14, the software distribution platform 1405 includes one or more servers and one or more storage devices. The storage devices store the computer readable instructions 1382, which may implement the computer vision pipeline functionality described throughout this disclosure. The one or more servers of the example software distribution platform 1405 are in communication with a network 1410, which may correspond to any one or more of the Internet and/or any of the example networks described throughout this disclosure. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers and/or licensors to download the computer readable instructions 1382 from the software distribution platform 1405. For example, software comprising the computer readable instructions 1382 may be downloaded to the example processor platform(s) 1400 (e.g., example connected edge devices), which is/are to execute the computer readable instructions 1382 to implement the functionality described throughout this disclosure. In some examples, one or more servers of the software distribution platform 1405 are communicatively connected to one or more security domains and/or security devices through which requests and transmissions of the example computer readable instructions 1382 must pass. In some examples, one or more servers of the software distribution platform 1405 periodically offer, transmit, and/or force updates to the software (e.g., the example computer readable instructions 1382 of FIG. 1B) to ensure improvements, patches, updates, etc. are distributed and applied to the software at the end user devices.

In the illustrated example of FIG. 14, the computer readable instructions 182 are stored on storage devices of the software distribution platform 1405 in a particular format. A format of computer readable instructions includes, but is not limited to, a particular code language (e.g., Java, JavaScript, Python, C, C#, SQL, HTML, etc.), and/or a particular code state (e.g., uncompiled code (e.g., ASCII), interpreted code, linked code, executable code (e.g., a binary), etc.). In some examples, the computer readable instructions 182 stored in the software distribution platform 1405 are in a first format when transmitted to the example processor platform(s) 1400. In some examples, the first format is an executable binary in which particular types of the processor platform(s) 1400 can execute. However, in some examples, the first format is uncompiled code that requires one or more preparation tasks to transform the first format to a second format to enable execution on the example processor platform(s) 1400. For instance, the receiving processor platform(s) 1400 may need to compile the computer readable instructions 182 in the first format to generate executable code in a second format that is capable of being executed on the processor platform(s) 1400. In still other examples, the first format is interpreted code that, upon reaching the processor platform(s) 1400, is interpreted by an interpreter to facilitate execution of instructions.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., Hypertext Transfer Protocol (HTTP)).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

### Examples

Illustrative examples of the technologies described throughout this disclosure are provided below. Embodiments of these technologies may include any one or more, and any combination of, the examples described below. In some embodiments, at least one of the systems or components set forth in one or more of the preceding figures may be configured to perform one or more operations, techniques, processes, and/or methods as set forth in the following examples.

Example 1 is a compute device, comprising: interface circuitry; and processing circuitry to: receive, via the interface circuitry, a video frame and video coding data for the video frame, wherein the video coding data includes motion vectors that indicate motion in the video frame; generate a modified video frame based on the video frame and the video coding data, wherein the modified video frame includes one or more areas of motion and a remaining one or more areas without motion, wherein the one or more areas of motion remain intact, and the one or more remaining areas are zeroed out; and detect content in the modified video frame.

Example 2 contains the subject matter of Example 1, wherein the video coding data associated with the video frame further includes: reference indices; block types; or transform domain characteristics.

Example 3 contains the subject matter of any one of Examples 1-2, wherein the processing circuitry comprises an artificial neural network (ANN) trained to detect content in video frames, and wherein: the processing circuitry is further to detect the content in the modified video frame by performing an inference on the modified video frame using the ANN.

Example 4 contains the subject matter of Examples 1-3, wherein the processing circuitry is further to generate the modified video frame by applying a threshold level of movement to the video frame to identify the one or more areas of motion.

Example 5 contains the subject matter of Example 4, wherein the processing circuitry is further to determine the threshold level of movement as based on the video coding data.

Example 6 contains the subject matter of Example 4, wherein the processing circuitry is further to: receive input from an optical flow circuitry; and determine the threshold level of movement as based on the input from the optical flow circuitry.

Example 7 contains the subject matter of Example 4, wherein the processing circuitry is further to: receive input from an event processor; and determine the threshold level of movement as based on the input from the event processor.

Example 8 contains the subject matter of any one of Examples 1 or 4-7, wherein the compute device is: an artificial intelligence accelerator; a vision processing unit; a media enhancement unit; a smart camera; a weatherproof computing appliance, a user device; an Internet-of-Things device; or an edge server appliance.

Example 9 is a method, comprising: receiving a video frame and motion vectors that indicate motion in the video frame; generating a modified video frame based on the video frame and the motion vectors, wherein the modified video frame includes one or more areas of motion and a remaining one or more areas without motion, wherein the one or more areas of motion remain intact, and the one or more remaining areas are zeroed out; and detecting content in the modified video frame.

Example 10 includes the subject matter of Example 9, further comprising, receiving: reference indices; block types; or transform domain characteristics.

Example 11 includes the subject matter of any one of Examples 9-10, further comprising detecting the content in the modified video frame by performing an inference on the modified video frame using an artificial neural network (ANN) trained to detect content in video frames.

Example 12 includes the subject matter of Example 11, further comprising generating the modified video frame by applying a threshold level of movement to the video frame.

Example 13 includes the subject matter of Example 12, further comprising receiving optical flow input; and determining the threshold level of movement as based on the optical flow input.

Example 14 includes the subject matter of Example 12, further comprising receiving input from an event processor; and determining the threshold level of movement as based on the input from the event processor.

Example 15 is a non-transitory machine-readable storage medium having instructions stored thereon, wherein the instructions, when executed on processing circuitry, cause the processing circuitry to: receive, via communication circuitry, a video frame and associated video signal characteristics; and generate, based on the video signal characteristics, a modified video frame, the modified video frame characterized by an area with a level of motion that exceeds a threshold level of movement intact, and remaining locations zeroed out.

Example 16 includes the subject matter of Example 15, wherein the instructions, when executed, further cause the processing circuitry to: determine a threshold level of movement as based on motion vectors included in the video signal characteristics; and generate the modified video frame by applying the threshold level of movement to the video frame.

Example 17 includes the subject matter of Example 15, wherein the instructions, when executed, further cause the processing circuitry to: receive input from an optical flow circuitry; and determine the threshold level of movement as based on the input from the optical flow circuitry.

Example 18 includes the subject matter of Example 15, wherein the instructions, when executed, further cause the processing circuitry to: receive input from an event processor; and determine the threshold level of movement as based on the input from the event processor.

Example 19 is a system, comprising: communication circuitry; and processing circuitry comprising an artificial neural network (ANN) trained to detect content in video frames, the processing circuitry to: receive, via the communication circuitry, a video frame and video coding data including motion vectors that indicate motion in the video frame; generate a modified video frame based on the video frame and the video coding data, wherein the modified video frame includes one or more areas having motion and a remaining one or more areas without motion, wherein the one or more areas of motion remain intact, and the one or more remaining areas are zeroed out; and detect content in the modified video frame by performing an inference on the modified video frame using the ANN.

Example 20 includes the subject matter of Example 19, wherein the video coding data associated with the video frame further includes: reference indices; block types; or transform domain characteristics.

Example 21 includes the subject matter of any one of Examples 19-20, wherein the processing circuitry is further to generate the modified video frame by applying a threshold level of movement to the video frame.

Example 22 includes the subject matter of claim 21, wherein the processing circuitry is further to determine the threshold level of movement as based on the video coding data.

Example 23 includes the subject matter of Example 21, wherein the processing circuitry is further to: receive input from an optical flow engine; and determine the threshold level of movement as based on the input from the optical flow engine.

Example 24 includes the subject matter of Example 21, wherein the processing circuitry is further to: receive input from an event processing engine; and determine the threshold level of movement as based on the input from the event processing engine.

Example 25 includes the subject matter of Example 19, wherein the system is: an artificial intelligence accelerator; a vision processing unit; a media enhancement unit; a smart camera; a user device; an Internet-of-Things device; or an edge server appliance.

While the concepts of the present disclosure are susceptible to various modifications and alternative forms, specific embodiments thereof have been shown by way of example in the drawings and are described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

What is claimed is:

1. A compute device, comprising:
interface circuitry; and
processing circuitry to:
receive, via the interface circuitry, a video frame that has been decoded and respective video coding data for the video frame, wherein the video coding data includes motion vectors that indicate motion in the video frame;
generate a modified video frame based on the video frame and the video coding data, wherein the modified video frame includes one or more areas of motion and a remaining one or more areas without motion, wherein the one or more areas of motion remain intact, and the one or more remaining areas are replaced with a zero; and
detect content in the modified video frame.

2. The compute device of claim 1, wherein the video coding data associated with the video frame further includes:
reference indices;
block types; or
transform domain characteristics.

3. The compute device of claim 1, wherein the processing circuitry comprises an artificial neural network (ANN) trained to detect content in video frames, and wherein:
the processing circuitry is further to detect the content in the modified video frame by performing an inference on the modified video frame using the ANN.

4. The compute device of claim 1, wherein the processing circuitry is further to generate the modified video frame by applying a threshold level of movement to the video frame to identify the one or more areas of motion, and wherein the modified video frame has a same size as the video frame.

5. The compute device of claim 4, wherein the processing circuitry is further to determine the threshold level of movement as based on the video coding data.

6. The compute device of claim 4, wherein the processing circuitry is further to:
receive input from optical flow circuitry; and
determine the threshold level of movement as based on the input from the optical flow circuitry.

7. The compute device of claim 4, wherein the processing circuitry to generate the modified video frame based on the video frame and the video coding data is further to:
preserve the video coding data after the video frame has been decoded;
reuse the video coding data to generate the modified video frame before the video coding data is discarded.

8. The compute device of claim 1, wherein the compute device is:
an artificial intelligence accelerator;
a vision processing unit;
a media enhancement unit;
a smart camera;
a user device;
an Internet-of-Things device; or
an edge server appliance.

9. A method, comprising:
receiving, from a video decode system, a video frame and respective motion vectors that indicate motion in the video frame;
generating a modified video frame based on the video frame and the motion vectors, wherein the modified video frame includes one or more areas of motion and a remaining one or more areas without motion, wherein the one or more areas of motion remain intact, and the one or more remaining areas are replaced with a constant; and
detecting content in the modified video frame.

10. The method of claim 9, further comprising:
receiving, for the video frame:
reference indices;
block types; or
transform domain characteristics; and
generating the modified video frame is further based on the reference indices, the block types or the transform domain characteristics.

11. The method of claim 9, wherein the modified video frame is a same size as the video frame, and further comprising detecting the content in the modified video frame by performing inference on the modified video frame using an artificial neural network (ANN) trained to detect content in video frames.

12. The method of claim 9, further comprising generating the modified video frame by applying a threshold level of movement to the video frame.

13. The method of claim 12, further comprising:
receiving optical flow input; and
determining the threshold level of movement as based on the optical flow input.

14. The method of claim 12, further comprising:
receiving event processing input; and
determining the threshold level of movement as based on the event processing input.

15. A non-transitory machine-readable storage medium having instructions stored thereon, wherein the instructions, when executed on processing circuitry, cause the processing circuitry to:
receive, via communication circuitry, a video frame and respective video signal characteristics; and
use the video signal characteristics to generate a modified video frame, the modified video frame characterized by an area with a level of motion that exceeds a threshold level of movement intact, and remaining locations zeroed out.

16. The storage medium of claim 15, wherein the instructions, when executed, further cause the processing circuitry to:
determine a threshold level of movement as based on motion vectors included in the video signal characteristics; and
generate the modified video frame by applying the threshold level of movement to the video frame.

17. The storage medium of claim 15, wherein the instructions, when executed, further cause the processing circuitry to:
receive an output from optical flow circuitry; and
determine the threshold level of movement based on the output from the optical flow circuitry.

18. The storage medium of claim 15, wherein the instructions, when executed, further cause the processing circuitry to:
receive event processing input; and
determine the threshold level of movement based on the event processing input.

19. A system, comprising:
communication circuitry; and
processing circuitry to:
receive from a video decode system, via the communication circuitry, a video frame and respective video coding data including motion vectors that indicate motion in the video frame;
use the video coding data to generate a modified video frame based on the video frame, wherein the modified video frame includes one or more areas having motion and a remaining one or more areas without motion, wherein the one or more areas of motion remain intact, and the one or more remaining areas are zeroed out; and
detect content in the modified video frame by performing inference on the modified video frame using an artificial neural network (ANN), wherein the ANN is trained to detect content in video frames.

20. The system of claim 19, wherein the video coding data further includes one or more of reference indices, block types, and transform domain characteristics.

21. The system of claim 19, wherein the processing circuitry is further to generate the modified video frame by applying a threshold level of movement to the video frame.

22. The system of claim 21, wherein the processing circuitry is further to determine the threshold level of movement as based on the video coding data.

23. The system of claim 21, wherein the processing circuitry is further to:
receive input from an optical flow system; and
determine the threshold level of movement as based on the input from the optical flow system.

24. The system of claim 21, wherein the processing circuitry is further to:
receive input from an event processing system; and
determine the threshold level of movement as based on the input from the event processing system.

25. The system of claim 19, wherein the system is:
a weatherproof appliance;
an artificial intelligence accelerator;
a vision processing unit;
a media enhancement unit;
a smart camera;
a user device;
an Internet-of-Things device; or
an edge server appliance.
